(19) United States
(12) Patent Application Publication
(10) Pub. No.: US 2004/0215545 A1
(43) Pub. Date: Oct. 28, 2004

(54) Power trading risk management system

(75) Inventors: Yoshiki Murakami, Kanagawa (JP); Nobuhisa Takezawa, Kanagawa (JP); Yuji Uenohara, Kanagawa (JP); Masatoshi Kawashima, Kanagawa (JP); Yuichi Kano, Tokyo (JP); Takahiro Tatsumi, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/768,444

(22) Filed: Feb. 2, 2004

(30) Foreign Application Priority Data
Jan. 31, 2003 (JP) 2003-024676

(51) Int. Cl. G06F 17/60

(52) U.S. Cl. 705/36

(57) ABSTRACT

A power trading risk management system includes means for evaluating and inputting a predicted value of an electricity demand, an electricity price in a spot market, a cost function of a power generator to be used, a fuel price, a fixed cost and the like, means for modeling a random fluctuation of a future electricity price by use of a fluctuation of a past electricity price, means for calculating a profit accrued from electricity sale and the like, means for evaluating a risk accrued from a random fluctuation of the electricity price, means for producing an appropriate electricity portfolio, means for reevaluating a value of the portfolio on a daily basis, means for reorganizing the portfolio for risk reduction, and means for deciding a price of a financial derivative instrument for risk hedging. The system measures a market risk associated with a power trading, and produces the portfolio for maximizing a profit while maintaining the risk within a tolerance.

### CORRESPONDING PATENT APPLICATION

This application is based upon and claims the benefit of priority from the prior Japanese Patent Applications No. 2003-024676 which was filed on Jan. 31, 2003.

### BACKGROUND OF THE INVENTION

The present invention relates to a power trading risk management system for managing a risk in a power trading.

An object of the present invention is to provide a method for allowing an electric power company possessing numerous power plants to procure electric power from a spot market on economically favorable terms and to respond to numerous electric power demands through related financial product transactions on economically favorable terms.

Another object of the present invention is to provide a power trading risk management technique which can manage a risk in a power trading by treating electric power in a spot market as a portfolio.

In Japan, power trading has been liberalized for retail exclusively for large-volume customers (users of 20000 V or 2000 kW and above) since March 2000. This partial liberalization is to be reviewed after three years and the liberalization is expected to be significantly expanded in 2004 or thereabout. When power trading is liberalized as described above, electricity prices will fluctuate depending on market situations. Fluctuations of electricity prices cause risks of fluctuations in profits and costs to electric power companies, electric power brokers and customers. Such situations are similar to that in the present stock market where stock prices fluctuate. In this concern, the financial and securities industries have developed methods for hedging (reducing or eliminating) risks of price fluctuations by use of financial engineering. Such financial engineering methods are deemed to be also effective in risk hedging against electricity prices.

Financial engineering provides the hypotheses that a future price fluctuates entirely at random and that the future price is not predictable at all except for a drift term which corresponds to an interest rate. However, the electricity prices are influenced by supply-demand relations more significantly in comparison with stocks and the like. Meanwhile, since the electricity demands generally drop at midnights or on weekends, fluctuations in a daily cycle or a weekly cycle is observed in the electricity prices. Moreover, as a result of large fluctuations of demands attributable to weather, the prices also tend to fluctuate in accordance with weather. Accordingly, seasonal fluctuations in a yearly cycle are also observed. Since such fluctuations are predictable to some extent, the hypothesis that the future price is not predictable at all is not always true unlike the case of stocks. Meanwhile, when the supply-demand relations are strained, the prices may soar and show spike-like fluctuations. These relations between the demands and prices described above constitute a concept unexpected in financial engineering. In addition, the electric power as a commodity has various characteristics including that it is difficult to preserve, that it generally costs very expensive, and that it is necessary to use a power transmission system to deliver the commodity. Therefore, the supply-demand relations are defined by electrical rules. From the reasons described above, the fluctuations of electricity prices show a slightly different aspect from the fluctuations of stocks.

It is necessary to evaluate numerically a quantity of risk in order to manage the risk of power trading. To this end, it is necessary to model fluctuations of a future electricity price. In such a case, the geometrical Brownian motion model is generally used in financial engineering. Here, a conventional technique will be explained using the case of a stock as an example. In financial engineering, a small deviation in stock price dS is generally described as in the following equation (1):

$$\frac{ⅆ S}{S} = μ ⅆ t + σ ⅆ z \qquad ( 1 )$$

Here, S is a stock price, μ is a drift rate (a trend term), t is time, σ is volatility, and z is a variable following the Wiener process.

The volatility is a factor showing uncertainties of future price fluctuations. This volatility is used in financial engineering to describe the magnitude of market price. The volatility corresponds to a standard deviation calculated on a yearly basis and is defined as the following equations (2):

$$\begin{matrix}σ = s / \sqrt{τ} \\ s = \sqrt{\frac{1}{n - 1} {\sum }_{i = 1}^{n} {( {u}_{i} - \overline{u} )}^{2}} \\ {u}_{i} = ln ( {S}_{i} / {S}_{i - 1} )\end{matrix} ) \qquad ( 2 )$$

Here, Sᵢ is a stock price (an electricity price in the case of electricity) at time i, and uᵢ is a continuous compound interest (or a rate of return) between time i−1 and i. If the price represents a price on every other day, then uᵢ is equivalent to a daily rate of return. Meanwhile, if the unit of the time period t is given in years, the σ becomes volatility of a yearly rate. The volatility is a factor indicating the scale of the price fluctuations.

In the meantime, the Wiener process is one of the Markov's stochastic processes, and is used in the field of physics to express a motion of micro particle, or the Brownian motion. The Wiener process is expressed as the following equation (3):

ti dz=ε\sqrt{dt} (3)

Here, dz is a change of z during an infinitesimal time period dt, and ε is a random sample from a standard normal distribution (at an average of 0 and a standard deviation of 1). The change dz is independent of different infinitesimal time periods dt.

The Wiener process (the Brownian motion), which has a drift term and in which a coefficient of dz is not 1 as shown in the equation (1), is so-called the generalized Wiener process (or the Ito process). The equation (1) also shows that a logarithm of the stock price performs the Brownian motion. Such a stochastic process is called the geometrical Brownian motion. In other words, the equation (1) is used to approximate fluctuations in the logarithms of the stock prices by using the sum of the random fluctuation term that fluctuates according to a normal distribution. This reflects the fact that investors are interested in rates of return more than the prices as they are. In evaluation of a risk of stock assets, usually, price fluctuations are modeled by the above-described geometrical Brownian motion model, and risk evaluation (measurement) is carried out according to the price distribution obtained as a result of such modeling.

For electricity prices, however, there has been a difficulty in accurately expressing the price distribution by use of the geometrical Brownian motion model. Hereinbelow, drawbacks of the conventional technique will be described based on examples of electricity prices from market data at California Power Exchange (CalPX) in the United States and at Leipzig Power Exchange (LPX) in Germany. Note that the electricity price data used herein are disclosed on the Internet (www.ucei.berkeley.edu/ucei).

FIG. 1A and FIG. 1B show electricity prices in daily average values in the day-ahead market at California Power Exchange (CalPX) in 1999 and 2000, respectively. Meanwhile, FIG. 1C shows electricity prices in daily average values at Leipzig Power Exchange (LPX) in 2001. FIG. 1D shows a transition of closing stock prices of Company A in 2001, which is provided herein for reference.

The first thing apparent from these graphs is that the fluctuations of the electricity prices and daily rates of return thereof are considerably greater than the fluctuations of the stock prices. As for the volatility, in contrast to 55% in the stock prices of Company A, the CalPX shows 343% in 1999 and 456% in 2000; meanwhile, the LPX shows 588% in 2001. Therefore, in each case, the volatility of the electricity prices is greater than the volatility of the stock prices by nearly 1 digit.

Prices of many derivative financial instruments are sensitive to volatility values. Accordingly, the conventional financial engineering method has a difficulty in hedging a risk of electricity trading. For example, a problem of an excessively high option price has been pointed out (Yoshiki Murakami et al.: Drafts for Summer Conference 2002, The Japanese Association of Financial Econometrics and Engineering, 2002).

Secondly, there is observed a phenomenon that a distribution of the rates of return deviates largely from the normal distribution. FIG. 2A shows a distribution of the rates of return in the daily average electricity prices at the CalPX, and FIG. 2B shows a distribution of the rates of return on a daily basis of the stock prices for Company A. Dot lines in the respective drawings show the normal distribution. In the probability distribution of the rates of return at the CalPX in FIG. 2A, it is apparent that bottom portions are greater than that of the normal distribution. Such a phenomenon is called a fat tail. This fat tail is observed frequently in energy-related commodities. Although the fat tail is also observed in the stocks, this phenomenon tends to be more significant in the electricity prices.

A deviation of the probability distribution from the normal distribution is expressed by stochastic quantities called skewness a₃ and kurtosis a₄. These quantities are defined by the following equations (4):

$$\begin{matrix}{α}_{3} = {\sum }_{i}^{} {( {x}_{i} - \overline{x} )}^{3} / N {σ}_{x}^{3} \\ {α}_{4} = {\sum }_{i}^{} {( {x}_{i} - \overline{x} )}^{4} / N {σ}_{x}^{4}\end{matrix} ) \qquad ( 4 )$$

Here, \overline{x} is an average value of data xᵢ, N is the number of the data, and ax is a standard deviation of the data. The kurtosis is equal to 3 in the case of the normal distribution, and becomes greater when the distribution becomes more acute. The skewness is equal to 0 in the case of a symmetrical distribution.

In the case of the CalPX electricity prices, the skewness a₃ is equal to 0.26 and the kurtosis a₄ is equal to 6.2. In other words, the distribution is substantially symmetrical but is more acute than the normal distribution. In the case of the stock prices of Company A in FIG. 2B, the skewness a₃ is equal to 0.2 and the kurtosis a₄ is equal to 3.3, which is substantially approximate to the normal distribution. A conventional financial engineering model usually assumes the normal distribution as the distribution of the rates of return. Accordingly, the conventional financial engineering method cannot be applied directly to power trading.

There is a method of numerically evaluating a volatility risk of a market price, which is called a value at risk (VaR). FIG. 3 is a graph showing a loss amount in a case where a value of an electricity asset is decreased to X_{L1} or below at a certain probability on the assumption that the value of the electricity asset fluctuates in accordance with the normal distribution based on the average μ and the standard deviation σ. This loss amount is a quantity of risk which is generally called the VaR. Here, the electricity asset is equivalent to a product of the electricity price and an amount of electric energy. It is possible to apply a similar definition in a case of multiple assets. Moreover, in a case of different kinds of assets, it is also possible to apply a similar definition by converting the assets into prices. As for the multiple assets, if the assets are correlated to one another, a standard deviation of a distribution of the whole assets can be calculated by use of correlation coefficients. In FIG. 3, on the assumption that the value of the asset is decreased to X_{L1} by 1% probability, the loss μ−X_{L1} is equal to 2.33×σ according to the normal distribution. As for the standard deviation σ, a standard deviation for a probability distribution in a targeted future period (in a month, for example) is used therein. This value is in proportion with a square root of the time in case of assuming the Brownian motion. Accordingly, the value can be calculated in an equation “σₓ=(volatility of yearly rate)×(period expressed in yearly unit)⁰⁵”.

The case in FIG. 3 is expressed as “the VaR in a month is μ−X_{L1} yen at 99% confidence level”. The magnitude of the risk is evaluated by the magnitude of this value.

Even if the distribution is not the normal distribution, a similar definition is applicable. FIG. 4 illustrates an example in which an asset value fluctuates in accordance with a probability distribution having a fat tail. A point corresponding to a cumulative probability (an area ratio of a portion of a probability distribution function below X_{L2}) of 1% is found and that point is defined as X_{L2}. In this case, since X_{L2}<X_{L1}, the loss amount or the VaR becomes greater at the same confidence level of 99%. In other words, evaluation of the VaR in the distribution having the fat tail on the assumption of the normal distribution results in underestimation. For this reason, it is important for risk evaluation to obtain the probability distribution of the future price as precisely as possible. However, the conventional method has a difficulty in evaluating the probability distribution.

In addition, an error in terms of the loss amount is another problem at a practical level. FIG. 5A and FIG. 5B collectively show a difference between the evaluation according to the VaR and actual profits. This approach is called a back test. In this case, daily losses or gains (differences between current-day prices and preceding-day prices) calculated based on the CalPX electricity prices in 1999 and the VaR figures calculated on the assumption of the normal distribution are illustrated. FIG. 5B is a partially expanded view of FIG. 5A. In the drawings, the values indicated with bars are the daily losses and gains per megawatt hour. The values indicated with dotted lines are the VaR figures per megawatt hour on the following days at 95% confidence level. Here, the volatility was calculated by use of the data for two weeks (14 days) before the point of evaluation.

From the drawings, it is apparent that a frequency of losses in excess of the VaR figures is about 1/20 (5%). However, it is learned that the loss amount may be enormous once the loss is incurred. Therefore, although the conventional method can accurately evaluate the frequency of losses, the method would underestimate the loss amount.

In addition to the foregoing problems, the risk management is far more complicated in the case of the electricity prices as compared to the stock prices because the relations with the demand or the weather must be taken into account.

Furthermore, the business strategy of an electric power company is drastically changed by the liberalization of power market. Specifically, major uncertainties prior to the liberalization were a demand fluctuation and an unexpected stoppage of a power generator (fuel costs have been basically passed to selling prices). Therefore, an object of the risk management has been to forecast the demand and to minimize power generation costs. In contrast, after the liberalization of power market, major risk factors are attributable to the fluctuations of the electricity prices. However, as described later, such risks are basically advantageous to the electric power company when appropriately managed. Specifically, the electric power company will have an option “not to generate power” after the liberalization. Such an option does not necessarily mean abandonment of responsibility of power supply, but means an option to stop the power generator and to procure electricity from a market for sales instead. In this case, a proportion between an amount of power generation by the electric power company and an amount of procurement from the market becomes important. A brief example will be described below in this concern.

Before the liberalization, assuming that a power generation cost per unit electricity is C, a fixed electricity price per unit electricity is P, and an amount demanded is L, then a profit of the electric power company per unit electricity is expressed by G₀=L(P−C).

Meanwhile, a profit of power generation after the liberalization will be as follows. Here, in order to discuss an ideal case, an assumption is made that there are sufficiently fluid spot markets. In addition, technical restrictions of the power generator are ignored and it is assumed that the power generator can freely generate power within the maximum electric power Q_{MAX}. Based on these assumptions, if the power generation cost per unit electricity is C, the fixed electricity price per unit electricity is P, the amount demanded is L (L≦Q_{MAX}), an amount of electricity generated is Q (Q≦Q_{MAX}), an amount of procurement from the market is B (which represents an amount of sales to the market when B is negative), and a spot price per unit electricity is S, the profit of power generation is described as follows:

(1) if S≦C, the amount of electricity generated Q=0, the amount of procurement B=L, and the profit G=L(P−S)≧G₀; and

(2) if S>C, the amount of electricity generated Q=Q_{MAX}, the amount of procurement B=−(Q_{MAX}−L), and the profit G=L(P−C)+(Q_{MAX})(S−C)>G₀.

That is to say, it is possible to gain the profit by stopping the power generation and procuring the whole amount from the market when the spot price is lower than the power generation cost. In other cases, it is possible to gain an additional profit by selling a portion exceeding the amount demanded out of the capacity of electric power facilities in the market. In each case, it is apparent that the profit is increased more after the liberalization. In reality, it is necessary to find B for maximizing the profit while satisfying the technical restrictions. Meanwhile, if there is a cost C′ which arises even when the power is not generated, then a condition of the procurement from the market is expressed by S≦C-C′.

In addition, when emission trading for CO₂ gas and the like is put into practice in the future, there is a possibility of an additional increase in profit by means of selling an emission right when stopping the power generation and procuring the electricity from the market instead. Since a thermal power plant has such an emission right as a matter of course, it is possible to gain profit by selling the right.

In consideration of one power plant and the spot market as described above, it is obvious that an optimum combination between these factors exists. In the case of using multiple power generators, a method of deciding the optimum combination is far more complicated because the power generation costs vary among the respective power generators.

The electric power company today owns many power plants with different power generation costs, and therefore decides the optimum combination of the power plants to meet the demand which is determined by external factors. However, when the power trading is liberalized, a method of deciding the optimum combination between the power plants and the demand is naturally changed due to the reasons that the electricity price varies with time and that the price varies depending on each demand. A portfolio concept used in the financial engineering field is applicable to such a method. The portfolio concept is a method of combining assets with different risks (time variation of the prices) and different profits most suitably. For example, it is possible to reduce the risk by combining assets of different types. Although a holding period is not considered very much in terms of simple portfolio optimization, there are concepts of a period for transmitting the electricity and a period for receiving the electricity in the case of an electricity asset. Therefore, the portfolio optimization method is required to take account of the time.

Various types of the electricity prices exist even today depending on conditions of contracts. The degree of freedom of price setting is increased when the power trading is liberalized. Accordingly, the electric power company will have many types of electricity assets with different prices and different holding periods. Assuming that the power generation cost is constant, the electricity assets will have different rates of return and different maturities. Derivative financial instruments such as futures or options are deemed to appear for the electricity assets sometime in the future. Methods for managing such derivative financial instruments are yet to be established even in overseas countries where the liberalization is advanced.

One portfolio management method considering the holding period is asset and liability management (ALM). When a mismatch between short-term funds and long-term funds occurs in a financial institution in terms of both fund operation and fund procurement, profitability declines due to differences in interest rates. To avoid this phenomenon, various methods have been developed to control the assets and the liabilities comprehensively.

The history of the ALM started a long time ago in early 1980's, involving maturity ladder analysis (for grasping repayment trends depending on interest rate ranks), maturity gap analysis, and sensitivity analysis to begin with. Later, as the importance of present value risk management has been recognized, and the ALM has developed into duration analysis, the value at risk (VaR), earning at risk (EaR), and the like. Recently, the ALM is also applied to credit risk management. The usual ALM mainly considers interest-rate fluctuations. However, this method is also applicable to the risk management of power trading. Nevertheless, the ALM method has not been used for management of electricity assets to date, except for some cases such as the VaR.

Accordingly, the electricity obtained from the power plant and the electricity procured from the market are deemed as financial assets with fixed maturities and dividend periods, and electricity demands based on various contracts are deemed as financial liabilities with fixed maturities and dividend periods in consideration of contracted amounts of electric energy, contract periods, contract conditions, and the like. Now, consideration will be made on a method of managing the financial assets and the financial liabilities as a portfolio while considering the maturities and the dividend periods thereof.

When the electric power facilities for supplying the electricity are managed depending on the magnitude of the risks so as to form the portfolio together with the electricity demands, the method for the optimum combination of the power generators (an economic dispatch) also becomes different. A combination for minimizing the power generation costs has been conventionally selected upon decision of the power generators to be operated (costs for starting and stopping the power generators are ignored here for the purpose of simplification). Such an approach corresponds to decision of a combination of power generator outputs to minimize the fuel costs with respect to the demand encountered. For example, assumptions are made that there are two power generators, a required amount of power generation is P₀, and optimum generated outputs are P₁ and P₂, respectively. When the power generation costs of the respective power generators are expressed by f₁(P₁) and f₂(P₂), then it is a question of deciding the values of P₁ and P₂ to minimize f₁(P₁)+f₂(P₂) on the condition of P₀=P₁+P₂. The optimum solutions for this question can be found by use of the Lagrange undetermined multiplier method. Here, with respect to F=f₁(P₁)+f₂(P₂)+λ(P₀-P₁-P₂) the following simultaneous equations (5) need to be resolved:

$$\begin{matrix}\frac{\partial F}{\partial {P}_{1}} = \frac{\partial {f}_{1}}{\partial {P}_{1}} - λ = 0 \\ \frac{\partial F}{\partial {P}_{2}} = \frac{\partial {f}_{2}}{\partial {P}_{2}} - λ = 0\end{matrix} ) \qquad ( 5 )$$

Therefore, the following equation (6) is obtained ultimately:

$$\frac{\partial {f}_{1}}{\partial {P}_{1}} = \frac{\partial {f}_{2}}{\partial {P}_{2}} = λ \qquad ( 6 )$$

The λ here is called an incremental fuel cost. That is, even when there are many power generators, those power generators should be appropriately operated so that the incremental fuel costs become equal.

For example, if f₁(P₁)=a₁P₁² and f₂(P₂)=a₂P₂², then the solutions of the equation (6) are as follows:

$$\begin{matrix}{P}_{1} = \frac{{a}_{2} {P}_{0}}{{a}_{1} + {a}_{2}} \\ {P}_{2} = \frac{{a}_{1} {P}_{0}}{{a}_{1} + {a}_{2}} \\ F = \frac{{a}_{1} {a}_{2} {P}_{0}^{2}}{{a}_{1} + {a}_{2}}\end{matrix} ) \qquad ( 7 )$$

Nevertheless, the final goal for the electric power company is not to minimize the power generation costs but to maximize the profit. When the electricity price is constant as in the past, minimization of the power generation costs is equal to maximization of the profit. However, things are different when the electricity price fluctuates as a result of the leberalization of power market. The method similar to the above is still applicable when considering only the individual power generators even in the case where the electricity price fluctuates. Actually, the minimization of the power generation costs is not always equal to the optimum combination of the power generators when considering the costs for starting and stopping the power generators and the like. In general, however, the costs for starting and stopping the power generators are relatively small.

The above-described simplification is not applicable when the prices vary depending on the demands. Moreover, considering that a power generator with a small risk should meet a demand with a small risk, for example, the minimization of the power generation costs is not equal to the optimum combination of the power generators because the fluctuations of the targeted electricity prices are different. Meanwhile, the minimization of the power generation costs is not equal to the optimum combination of the power generators when a power generation plan is made by selecting the power generators in response to the periods and the amounts of the demands from the market and so on. Therefore, the economic operation method based on the incremental fuel costs as in the past does not provide the optimum result under the liberalization of power market.

As described above, when power trading is liberalized, more various electricity commodities will appear than those at present. In the meantime, the electricity prices will vary depending on the demands and the electricity prices even vary with time. To deal with such fluctuations, the conventional technique has a difficulty in comprehensively managing the assets including the power supply and the power demand. Moreover, from the viewpoint of the electricity asset, time factors such as the electricity transmission period or the electricity reception period are important. However, since the conventional method does not take such factors into account, it is difficult to optimize the portfolio. In addition, since the price distribution of such assets is largely deviated from the normal distribution, the conventional model causes a large error. On the other hand, when the electric power company executes power trading under the liberalized electricity market, the electric power company cannot maximize the profit by merely considering the power generation costs. Furthermore, it is difficult to maximize the profit while maintaining the risk within a tolerance, and it is difficult to optimize the risk management for each power plant.

### SUMMARY OF THE INVENTION

One aspect of the present invention is a power trading risk management system, in which electricity obtained from a power plant and electricity procured from a power trading market are deemed as financial assets with fixed maturities and dividend periods, while electricity demands based on various contracts are deemed as financial liabilities with fixed maturities and dividend periods in consideration of contracted amounts of electric energy, contract periods, contract conditions, and the like, whereby these assets are comprehensively managed as an electricity portfolio considering the maturities and the dividend periods.

Another aspect of the present invention is a power trading risk management system comprising: an electricity procurement planning unit for producing an electricity procurement plan by combining electricity to be generated by one or plural owned power generators and electricity to be procured from a market; a generation-procurement curve producing unit for producing a generation-procurement curve based on the electricity procurement plan; a portfolio producing unit for producing a portfolio of electricity to be generated by owned power plants and electricity to be procured from a power trading market that is matching to the generation-procurement curve; a risk evaluation unit for evaluating a risk of the portfolio; a profit estimating unit for estimating a profit of electricity sale according to the portfolio; a portfolio reorganizing unit for reorganizing the portfolio; a best portfolio proposing unit for judging a best portfolio which can maximize the profit while maintaining the risk in the profit of electricity sale in a certain period within a tolerance among the reorganized portfolios.

According to this aspect, the power trading risk management system can further include: means for deciding a combination of power generators to be operated to maximize a profit accrued from power generation.

According to this aspect, the power trading risk management system can further include: an estimation of future electricity demand unit for estimating fluctuations of future electricity demand according to past electricity demand fluctuations; and an estimation of electricity price fluctuation unit for estimating future electricity price fluctuations according to the past electricity demands, past price fluctuations and a relationship between electricity demand and price in a predetermined period as well as the estimated fluctuations of future electricity demand; and in the system, it is possible to configure that the portfolio producing unit includes a price of an emission right for carbon dioxide in the portfolio; and the best portfolio proposing unit judges the best portfolio which can maximize the profit while maintaining the risk in the profit of electricity sale in a certain period within the tolerance among the reorganized portfolios which are including the price of the emission right of carbon dioxide.

According to this aspect, the power trading risk management system can further include: an estimation of future electricity demand unit for estimating fluctuations of future electricity demand according to past electricity demand fluctuations; and in the system, it is possible to configure that the portfolio producing unit includes a financial product related to a weather in a corresponding region in the portfolio; and the best portfolio proposing unit judges the best portfolio which can maximize the profit while maintaining the risk in the profit of electricity sale in a certain period within the tolerance among the reorganized portfolios which are including the financial product related to the weather.

According to this aspect, in the power trading risk management system, it is possible to configure that the risk evaluating unit manages a position and calculates a risk index for the electricity portfolio by use of the relationship between demand and price which varies depending on a country, a region, and time wherein the system is operated.

According to this aspect, in the power trading risk management system, it is possible to configure that the risk evaluating unit uses at least any of volatility, risk sensitivity, skewness of a rate of return distribution, kurtosis of the rate of return distribution, a percent point of the rate of return distribution, a percent point of a price distribution, a value at risk and an earning at risk for managing the position and calculating the risk index for the electricity portfolio.

According to this aspect, in the power trading risk management system, it is also possible to configure that the risk evaluating unit uses a probability distribution different from a normal distribution as a distribution of the rate of return attributable to a power trading upon risk evaluation of the portfolio.

According to this aspect, in the power trading risk management system, it is possible to configure that the risk evaluating unit uses a probability distribution different from a normal distribution that is calculated from a financial Boltzmann model as a distribution of the rate of return attributable to a power trading upon risk evaluation of the portfolio.

Another aspect of the present invention is a power trading risk management system, comprising: a power generation risk parameter evaluating unit for simulating a fluctuation of a profit of each power plant and evaluating a risk parameter of power generation by use of a fluctuation of a fuel price; an electricity procurement risk parameter evaluating unit for evaluating a risk parameter of electricity to be procured from a power trading market; an electricity demand risk parameter evaluating unit for evaluating a risk parameter of an electricity contract with each customer; a portfolio producing unit for producing a portfolio according to a proportion of electricity to be generated by owned power plants and electricity to be procured from a power trading market, the risk parameter of power generation, the risk parameter of electricity procurement and the risk parameter of electricity contract; a risk value evaluating unit for evaluating a risk of the portfolio; a portfolio reorganizing unit for reorganizing the portfolio by adjusting the proportion of the electricity to be generated by owned power plants and electricity to be procured from the market to maximize a profit while maintaining the risk amount within a tolerance; and an outputting means for deciding the proportion of the electricity to be procured from the market which can maximize the profit while maintaining the risk amount within the tolerance as an optimum combination and outputting the optimum combination as a power generation plan.

According to this aspect, the power trading risk management system can further include: means for deciding a combination of power generators to be operated to maximize a profit accrued from power generation.

According to this aspect, in the power trading risk management system, it is possible to configure that the risk value evaluating unit uses an asset and liability management method of any of maturity ladder analysis, term gap analysis, and duration gap analysis for management of the portfolio.

Still another aspect of the present invention is a power trading risk managing method, comprising the steps of: producing an electricity procurement plan by combining electricity to be generated by one or plural owned power generators and electricity to be procured from a market; producing a generation-procurement curve based on the electricity procurement plan; producing a portfolio of electricity to be generated by owned power plants and electricity to be procured from a power trading market that is matching to the generation-procurement curve; evaluating a risk of the portfolio; estimating a profit of electricity sale according to the portfolio; reorganizing the portfolio; and judging a best portfolio which can maximize the profit while maintaining the risk in the profit of electricity sale in a certain period within a tolerance among the reorganized portfolios.

Still another aspect of the present invention is a power trading risk managing method, comprising the steps of: simulating a fluctuation of a profit of each power plant; evaluating a risk parameter of power generation by use of a fluctuation of a fuel price; evaluating a risk parameter of electricity to be procured from a power trading market; evaluating a risk parameter of an electricity contract with each customer; producing a portfolio according to a proportion of electricity to be generated by owned power plants and electricity to be procured from a power trading market, the risk parameter of power generation, the risk parameter of electricity procurement and the risk parameter of electricity contract; evaluating a risk of the portfolio; reorganizing the portfolio by adjusting the proportion of the electricity to be generated by owned power plants and electricity to be procured from the market to maximize a profit while maintaining the risk amount within a tolerance; deciding the proportion of the electricity to be procured from the market which can maximize the profit while maintaining the risk amount within the tolerance as an optimum combination; and outputting the optimum combination as a power generation plan.

### BRIEF DESCRIPTION OF THE DRAWINGS

FIG. 1A is a graph showing electricity prices in daily average values at California Power Exchange (CalPX) in 1999.

FIG. 1B is a graph showing electricity prices in daily average values at California Power Exchange (CalPX) in 2000.

FIG. 1C is a graph showing electricity prices in daily average values at Leipzig Power Exchange (LPX) in 2001.

FIG. 1D is a graph showing a transition of closing stock prices of Company A in 2001.

FIG. 2A is a distribution graph showing rates of return in the daily average electricity prices at California Power Exchange (CalPX).

FIG. 2B is a distribution graph showing rates of return on a daily basis of the stock prices for Company A.

FIG. 3 is a graph showing a loss amount (VaR) when a value of an asset is decreased to X_{L1} or below at 1% probability on the assumption that the asset fluctuates in accordance with a normal distribution based on an average μ and a standard deviation σ.

FIG. 4 is a graph showing a loss amount when a price is decreased to X_{L2} or below at 1% probability on the assumption that the price fluctuates in accordance with a probability distribution having a fat tail.

FIG. 5A is a graph showing profits of daily average electricity prices at California Power Exchange (CalPX) and showing VaR figures on the following days at 95% confidence level.

FIG. 5B is a partially expanded view of FIG. 5A.

FIG. 6 is a block diagram showing a functional configuration of a first embodiment of the present invention.

FIG. 7A is an explanatory view for a portfolio of electric power demands.

FIG. 7B is an explanatory view for a portfolio of conventional electricity procurement.

FIG. 7C is an explanatory view for a portfolio of electricity procurement according to the first embodiment.

FIG. 8 is a table showing a concept of electricity asset and liability management.

FIG. 9 is a block diagram showing a functional configuration of an electricity procurement plan producing unit of a second embodiment of the present invention.

FIG. 10A and FIG. 10B are a flowchart showing a process carried out by the electricity procurement plan producing unit of the second embodiment.

FIG. 11 is a block diagram showing a functional configuration of an electricity procurement plan producing unit of a third embodiment of the present invention.

FIG. 12 is a flowchart showing a process carried out by the electricity procurement plan producing unit of the third embodiment.

FIG. 13A is a graph showing a relation between an electricity demand and an electricity price at California Power Exchange (CalPX) in February, 1999.

FIG. 13B is a graph showing a relation between an electricity demand and an electricity price at California Power Exchange (CalPX) in August, 1999.

FIG. 14A is a graph showing a relation between an electricity demand and an electricity price at Leipzig Power Exchange (LPX) in February, 2001.

FIG. 14B is a graph showing a relation between an electricity demand and an electricity price at Leipzig Power Exchange (LPX) in August, 2001.

FIG. 15 is a block diagram showing a functional configuration of a fourth embodiment of the present invention.

FIG. 16 is a flowchart showing a process carried out by the electricity procurement plan producing unit of the fourth embodiment.

FIG. 17 is a view for removing periodicity out of electricity prices.

FIG. 18A is a graph plotting variation with time of skewness by using data of California Power Exchange (CalPX).

FIG. 18B is a graph plotting variation with time of kurtosis by using the data of California Power Exchange (CalPX).

FIG. 19A is a graph showing fluctuations of electricity prices close to a normal distribution, which are calculated by use of a financial Boltzmann model according to a fifth embodiment of the present invention.

FIG. 19B is a graph showing fluctuations of electricity prices largely deviated from the normal distribution, which are calculated by use of the financial Boltzmann model according to the fifth embodiment of the present invention.

FIG. 19C is a graph showing daily rates of return corresponding to the fluctuations of electricity prices shown in FIG. 19A.

FIG. 19D is a graph showing daily rates of return corresponding to the fluctuations of electricity prices shown in FIG. 19B.

FIG. 20A is a graph showing a difference between a normal distribution model and the financial Boltzmann model employing VaR figures at 95% confidence level.

FIG. 20B is a partially expanded view of FIG. 20A.

FIG. 21A is a graph showing a relation between an absolute value of a daily rate of return and a demand at the CalPX.

FIG. 21B is a graph showing a relation between a daily rate of return and a traded volume of stocks for Company A.

FIG. 22 is a graph showing a relation between an absolute value of a daily rate of return on a current day and a daily rate of return on the preceding day at the CalPX.

FIG. 23 is a graph showing a result of fitting by use of a temperature function.

FIG. 24 is a block diagram showing a functional configuration of a sixth embodiment of the present invention.

FIG. 25 is an explanatory view showing an output screen of a comprehensive power trading risk management system incorporating various functions of the first to sixth embodiments of the present invention.

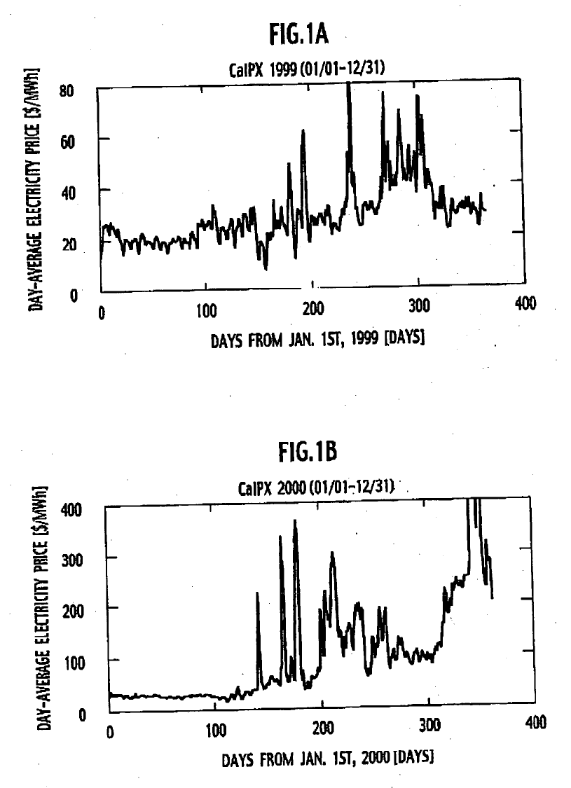

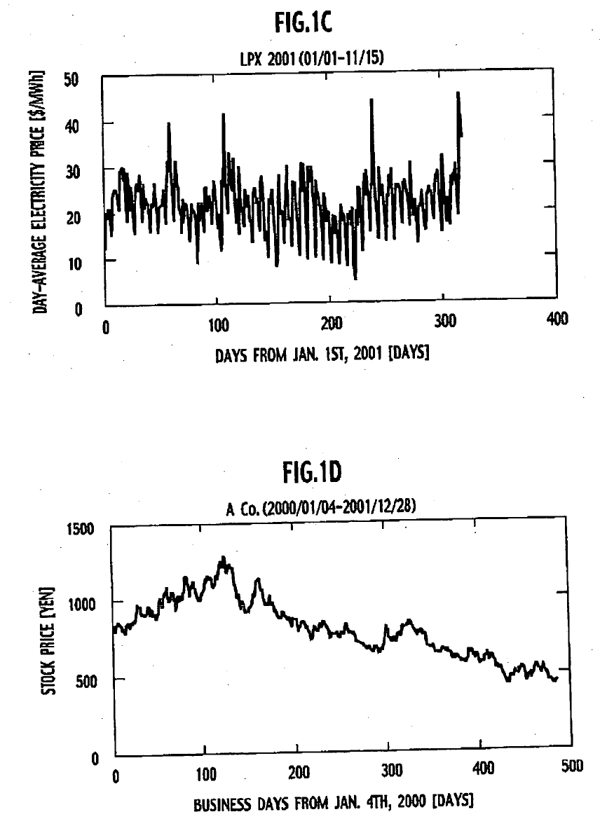

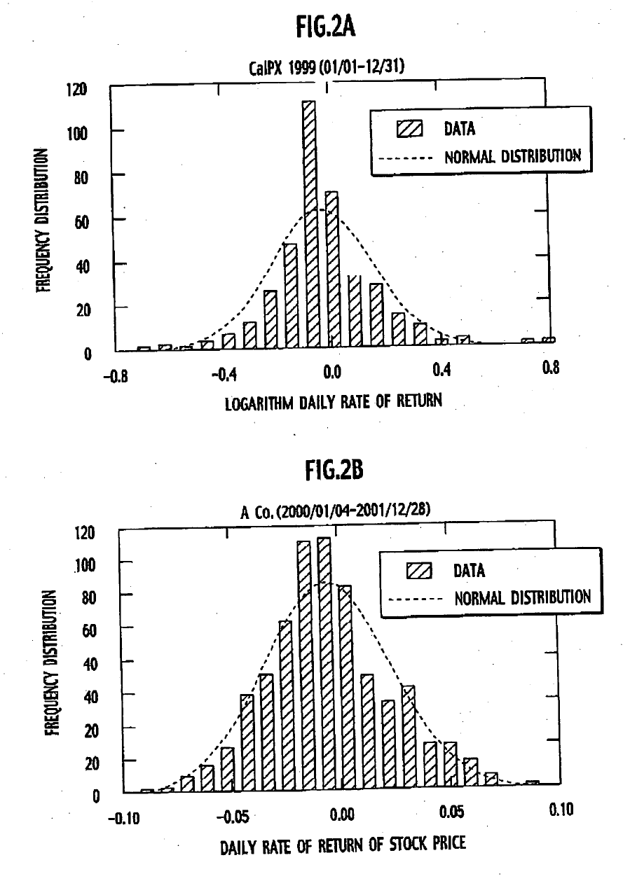

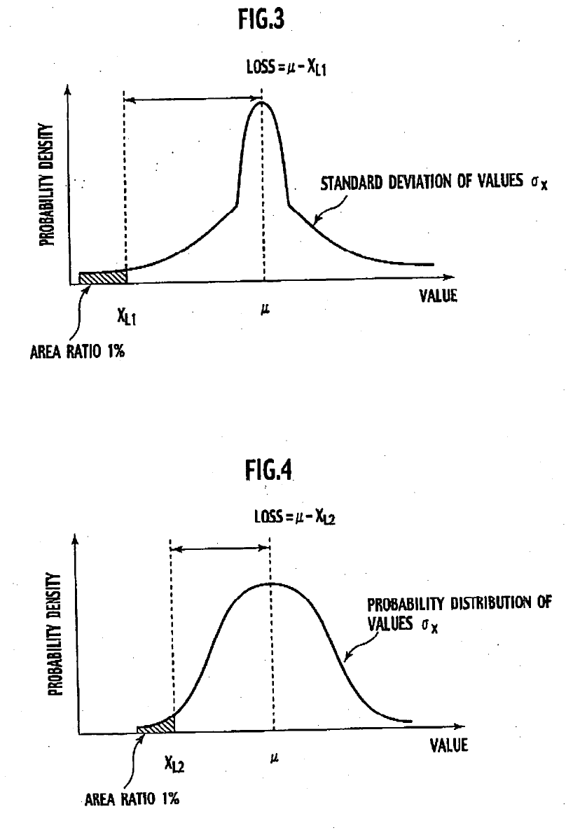

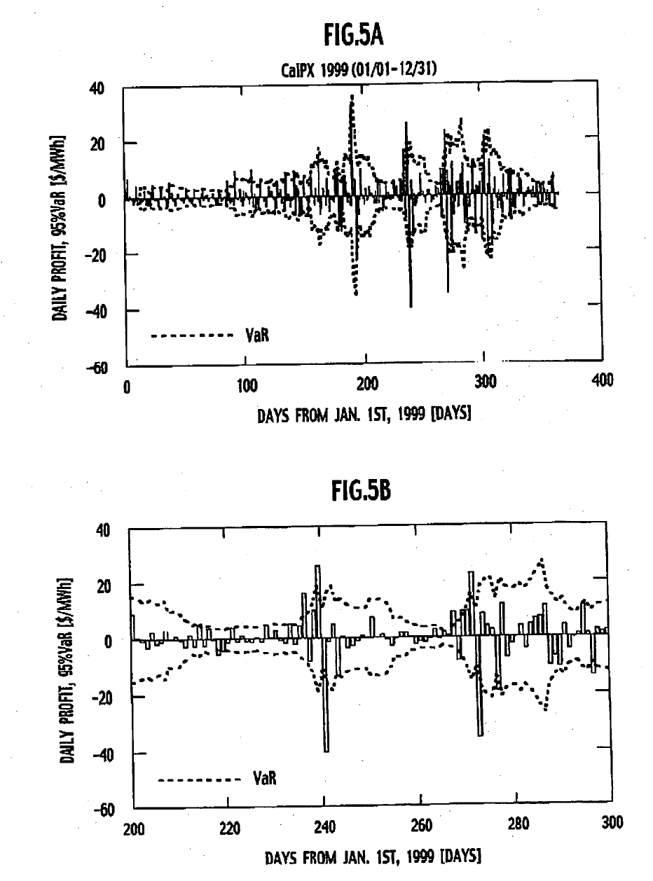

### DESCRIPTION OF THE PREFERRED EMBODIMENTS

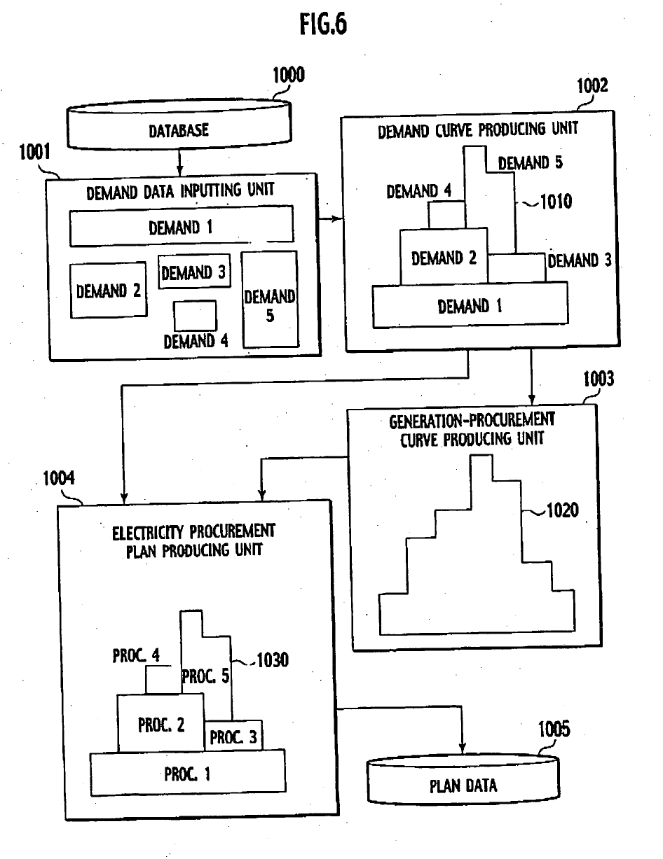

Now, embodiments of the present invention will be described in detail with reference to the accompanying drawings. FIG. 6 shows a functional configuration of a power trading risk management system according to a first embodiment of the present invention. In this power trading risk management system, a demand data inputting unit 1001 inputs targeted demand related data, which are individual amounts demanded as a time function and risk indices thereof. A demand curve producing unit 1002 produces a demand curve 1010 for a certain period by use of the demand related data inputted by the demand data inputting unit 1001. A total generation-procurement curve producing unit 1003 produces a total generation-procurement curve 1020 proximately. The demand curve 1010 to be produced by the demand curve producing unit 1002 is equal to the total generation-procurement curve 1020 to be produced proximately by the total generation-procurement curve producing unit 1003.

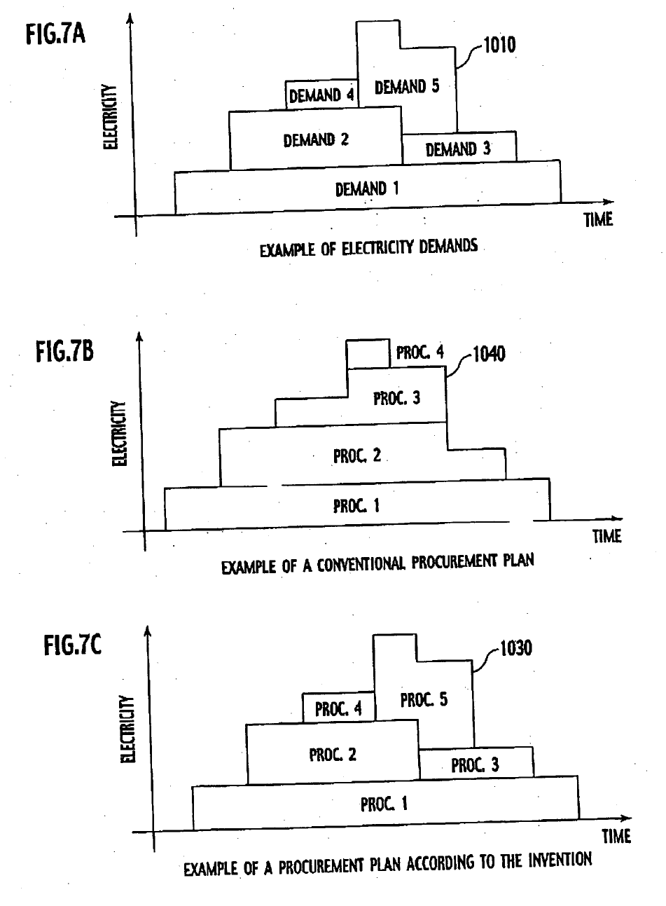

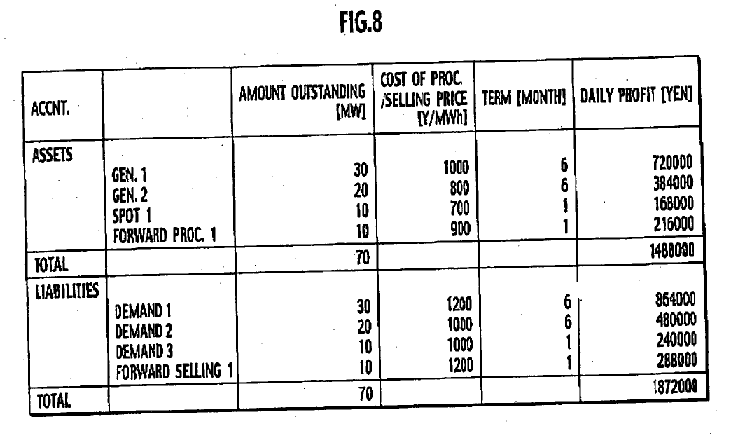

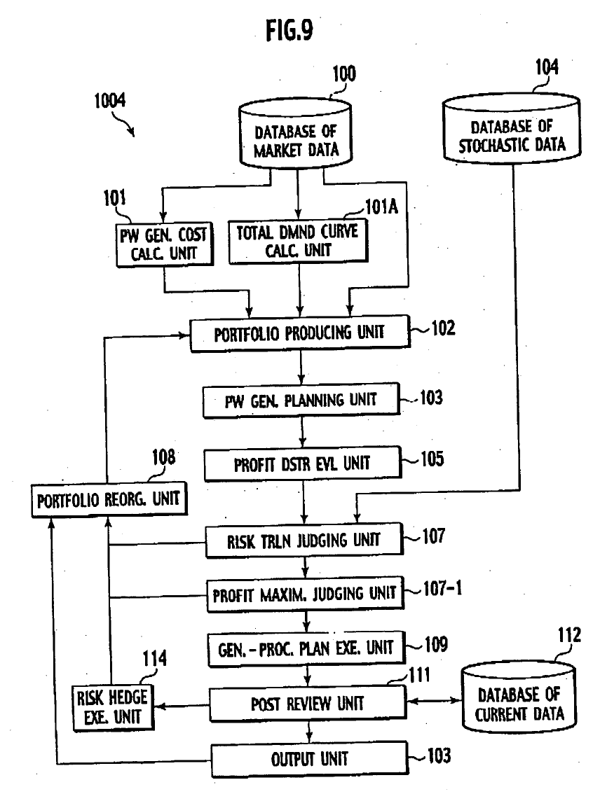

An electricity procurement plan producing unit 1004 matches amount and time of power generation (or procurement) as closely as possible with amount and time of a demand, and thereby produces a plan for operating power generators and a plan for procuring electricity from a market or another electric power company as shown by a power generation-procurement plan curve 1030. Moreover, the electricity procurement plan producing unit 1004 outputs the plans as target data 1005 for generation and procurement. FIG. 7A to FIG. 7C show a result of the above-described procedures in comparison with a conventional method.

FIG. 7A to FIG. 7C show a principle of producing an optimum power generation plan by use of the power trading risk management system of the first embodiment. In general, a maximum amount of electric energy and a delivery period are set forth in an electricity contract. Accordingly, a discussion in terms of a certain section of time is not appropriate herein, but a discussion in consideration of a time axis is required. FIG. 7A conceptually illustrates this approach. In this case, there are five customers, and a sum of demands of the five customers constitutes the demand curve 1010. The lateral axis indicates the time. Actual contract conditions are not simple; in addition, electricity to be used is not always constant at any time. However, for the purpose of simplification, the individual demands are represented in rectangular shapes. On the contrary, a procurement side conventionally operates power generators in the order of low power generation costs as shown by a total power generation-procurement curve 1040 in FIG. 7B. When a power generator having the lowest power generation costs reaches the maximum generation capacity, then a power generator having the second lowest power generation costs is operated, and so on. In reality, a base power source is sometimes selected due to a difficulty in starting and stopping operation or changing output. Accordingly, it is not always true that the power source having the lowest costs is simply the first to be operated. Nevertheless, when the price does not fluctuate with time, which means when there is no risk, the above-described concept generally works out. There is no reason for applying an expensive power source deliberately as a base power source.

On the contrary, when the electricity price fluctuates with time along with the liberalization of power market, it is not appropriate to decide the power generators to be operated merely depending on the power generation costs. In other words, it is necessary to consider risk factors. As rates of return vary among the power generators and price volatility risks are also different, it is necessary to adopt a so-called portfolio approach. A rate of return Y in a portfolio is equal to a weighted average of rates of return yᵢ in terms of respective assets. Specifically, when a weight of the respective assets is wᵢ, the rate of return Y is given by the following equation (8):

$$Y = {\sum }_{i}^{} {w}_{i} {y}_{i} \qquad ( 8 )$$

In this case, a variance σ_{Y}² of Y is expressed by the following equation (9):

$${σ}_{Y}^{2} = {\sum }_{i}^{} {w}_{i}^{2} {σ}_{i}^{2} + {\sum }_{i}^{} {\sum }_{j \neq i}^{} {w}_{i} {w}_{j} {σ}_{ij} \qquad ( 9 )$$

where, σᵢⱼ is a covariance between the assets i and Assuming that there are i−1 pieces of assets, estimation of an aspect of change in risk, which is variance of risk, in a new portfolio caused by adding one new asset i is the most important part of the portfolio theory. The aspect of change in risk in the entire portfolio to be caused by adding the i-th asset thereto can be obtained by partial differentiation of the equation (9) with respect to wᵢ. Specifically, the following equation (10) is applied hereto:

$$\frac{\partial {σ}_{Y}^{2}}{\partial {w}_{i}} = 2 {w}_{i} {σ}_{i}^{2} + 2 {\sum }_{j \neq i}^{} {w}_{j} {σ}_{ij} = 2 Cov ( {y}_{i} , Y ) \qquad ( 10 )$$

The equation (10) corresponds to a covariance between the i-th asset and the entire portfolio. Specifically, it is apparent that the risk in the new portfolio is not influenced by the variance of the i-th asset but by the covariance with other assets. In short, an electric power company needs to judge as to whether it is appropriate to acquire a new demand or not on the basis of a relation with other demands.

The above-described value at risk (VaR) is also used when evaluating the risk in the portfolio. For example, the VaR of a current portfolio is assumed to be 100 million yen. Here, an assumption is made that there is a necessity to enter into a new electricity contract estimating a profit of 20 million yen. The value of this transaction is assumed to be 30 million yen, for example. In this case, a proportion between the risk and the return is 3:2, and the transaction is not deemed efficient. However, if the entire VaR is increased by 10 million yen and consequently reaches 110 million yen by incorporating the new transaction into the portfolio, then the transaction is efficient because the proportion between the risk and the return is 1:2. Thus, it is not appropriate to judge a benefit of a transaction merely by considering the profits of the respective power trading.

The same holds true with a relation between a supply and demand. As the electricity contract is also a sort of properties, the contract is divided into an asset, which is a positive property, and a liability, which is a negative property. When applying this concept to a practice in the financial and securities industries, the asset corresponds to the electricity to be generated or the electricity to be procured from the market, and the liability corresponds to the electricity to be supplied to the customers.

Usually, the asset is equal to a sum of the liability and a capital. However, the capital is assumed to be 0 in this case. Imbalance between the demand and supply in the power trading leads to a blackout. Accordingly, the asset and the liability are deemed to be balanced without any margin that corresponds to the capital. An ALM approach as practiced by a financial institution is also effective to manage this supply-demand relation. In this case, it is possible to consider that fluctuations of the electricity price correspond to fluctuations of an interest rate in the conventional technique. The asset and the liability may include one with high uncertainty and risk or one with low uncertainty and risk. Therefore, it is possible to properly maintain the portfolio in response to the fluctuation of the electricity price (to maximize an expected return in response to risk tolerance) by means of appropriately combining short-term contracts and long-term contracts, or high-risk contracts and low-risk contracts. The power generation-procurement plan curve 1030 in FIG. 7C conceptually illustrates this approach. In this case, the optimum procurement is conducted so as to correspond to the respective demands instead of adding the power generators in the order of low costs as described by the total power generation-procurement curve 1040 in FIG. 7B. The demand and procurement are represented similarly by rectangular blocks in the drawings. In reality, however, the demand and the procurement need to be adjusted individually from the viewpoints of the risks and the profits. In other words, it is necessary to conduct the optimum procurement to meet the demand instead of simply operating the power generators in the order of low costs.

Concrete methods to be used for achieving the optimum procurement include maturity ladder analysis, term gap analysis or duration gap analysis. The maturity ladder analysis is an analysis method to compile maturities of the assets and liabilities which are currently possessed. This method is suitable for producing a database of the assets. The term gap analysis is a method of compiling the data of the maturity ladder analysis while dividing the data into each section of terms such as one month and thereby grasping gaps of matured amounts among the respective terms. This method is used to calculate sensitivity of profits when interest rates fluctuate.

Although there may be a case in which an interest-rate risk needs to be evaluated in the power trading, description will be made herein on a method of an analysis of sensitivity to a price risk. An assumption will be made herein that a relation between the electricity procurement and the electricity demand are as shown in FIG. 8, for example. A change in profit when the electricity price is increased by 100 yen, for example, is easily calculated by use of FIG. 8. Since the demand and the supply are formed of the same amounts and terms, the price volatility risk is cancelled herein. If the respective amounts and terms are different between the demand and the supply, the price volatility risk is not cancelled. Duration is a tool for easily expressing such a situation.

In the financial field, price volatility of a coupon bond generally becomes larger as a remaining period is longer, assuming that the coupons, which are cash flows, have the same values. Therefore, the remaining period of the bond functions as a scale for the price volatility. Accordingly, a period weighted by present values of the cash flows is the duration. The duration is defined by the following equation (11):

$$D = {\sum }_{i}^{} \frac{{c}_{i} exp ( - r {t}_{i} )}{P} {t}_{i} \qquad ( 11 )$$

where, r is an interest rate, which is a yield to maturity of the coupon bond, and P is a price of the coupon bond where cᵢ is paid at tᵢ.

Roughly speaking, in terms of the electricity price as well, the price volatility risk becomes larger as the term of the contract is longer or the price is higher. Therefore, it is possible to evaluate the price sensitivity by defining an amount corresponding to the duration.

When the electricity generated by the power generator is deemed as the asset, a merit or a demerit of the asset can be evaluated by use of the rate of return. A rate of return of a risk asset such as a stock or a security is a sum of an income gain and a capital gain. Since there is no income gain in the case of the electricity, it is only necessary to consider the capital gain attributable to the fluctuations of the electricity price. When a future price is unknown, the rate of return can be deemed as a stochastic variable and a profit or a loss of the electricity asset can be expressed as a probability distribution function. Practically, the distribution of the rate of return is estimated by use of past data based on the assumption that observed values are independent and accord to the same distribution. When one period from a time point j−1 to a time point j is referred to as a period j, the rate of return in the period j is expressed by the following equation (12):

$${R}_{j} = \frac{{S}_{j} - {S}_{j - 1}}{{S}_{j - 1}} \qquad ( 12 )$$

where, Sⱼ is the electricity price at the time point j. Fluctuations of a fuel price are not taken into account in this case. A continuous compound rate of return in the period j is calculated by the following equation (13):

$${R}_{j} = ln ( \frac{{S}_{j}}{{S}_{j - 1}} ) \qquad ( 13 )$$

If one period is equal to one day, then the latter portion of the equation (13) is a logarithmic daily rate of return.

As described above, the duration is the remaining period of the portfolio weighted by the present values of the cash flows. In the case of the electricity asset, or liability, the cash flows c(t) are deemed to be continuous. Accordingly, the duration d can be defined as the following equation (14):

$$d = {\sum }_{i}^{} \frac{{\int }_{0}^{{c}_{i}} {c}_{i} ( t ) {ⅇ}^{- rt} t ⅆ t}{{\int }_{0}^{{c}_{i}} {c}_{i} ( t ) {ⅇ}^{- rt} ⅆ t} \qquad ( 14 )$$

where, r is the interest rate, cᵢ(t) is a cash flow at time t of an i-th element in the portfolio of outstanding contracts, and τᵢ is a contracted term thereof. Therefore, the duration continuously changes as a time function in this case. Since the cash flow changes depending on the contents of the contract or fluctuations of a market price, the duration of the portfolio will be calculated by use of a Monte Carlo simulation. It is necessary to find a probability distribution of the duration, depending on the case.

In general, it is known to be possible to immunize a market risk in the portfolio by matching the duration of the portfolio with a period of investment (L. Fisher and R. Weil, Journal of Business, (1971) pp. 408-431). This is applicable to a case of a parallel shift of an interest-rate risk. However, it also holds true for the fluctuations of the electricity price approximately in terms of short-term risk evaluation. In the case of a long-term risk or drastic price volatility, it is necessary to decide an optimum portfolio combination by executing the Monte Carlo simulation.

When a future is usable, the portfolio duration can be changed without modifying a spot position. The portfolio risk is increased when invested in an asset with long duration. In this case, it is possible to shorten the duration by selling a future.

Moreover, in the financial field, the portfolio is regularly reorganized by use of a swap transaction between a short-term interest rate and a long-term interest rate and the like. Such techniques are also applicable to the risk management of the electricity portfolio.

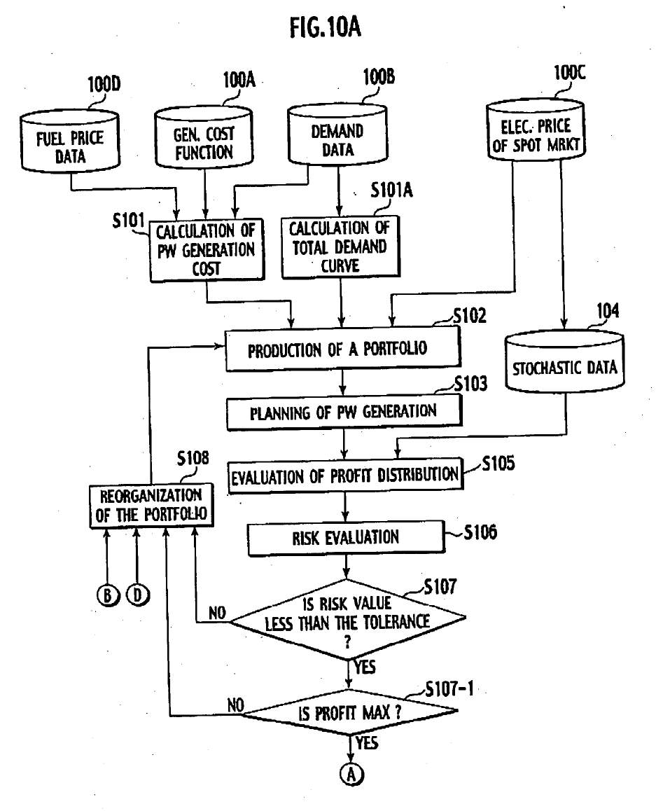

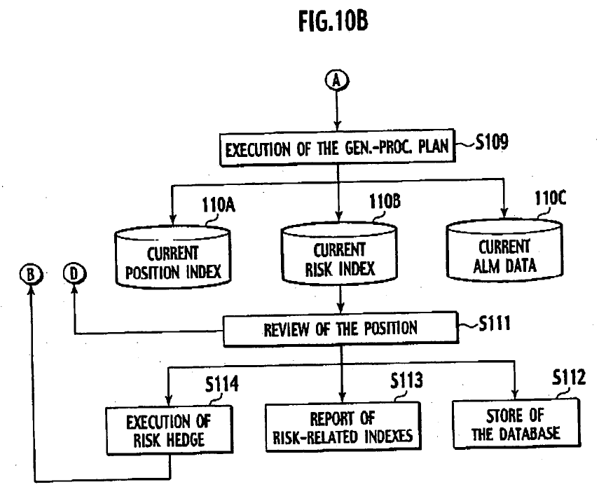

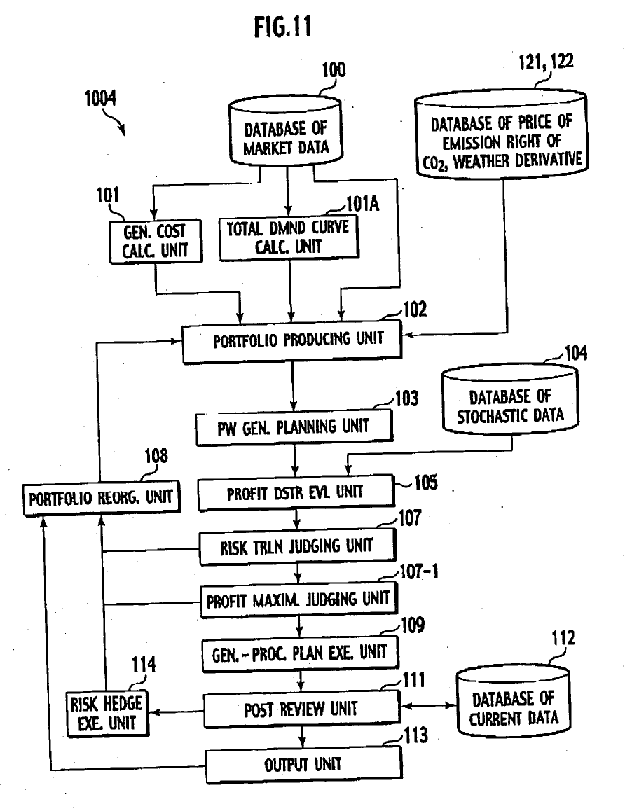

FIG. 9 shows a functional configuration of an electricity procurement plan producing unit 1004 as a second embodiment of the present invention, which can be employed in the power trading risk management system of the first embodiment. FIG. 10A and FIG. 10B is a flowchart of a process carried out by the electricity procurement plan producing unit 1004. Here, description will be made on functions for producing an electricity procurement plan by combining electricity to be generated by owned power generators and electricity to be procured from a market, comprehensively managing the plan as a portfolio while comparing the plan with demand data, and thereby maximizing a profit while maintaining a risk of a profit raised by sale of electricity for a certain period within a tolerance.

In a market database 100, various kinds of market-related data such as spot electricity price data, generation price data, contract term data, those are necessary for this system, interest rate data are stored.

Since a power generation cost is expressed by a function of an amount of power generation, a power generation cost calculating unit 101 determines the power generation cost by use of a cost function 100A for a power plant, demand data 100B and fuel price data 100D (Step S101). Although a conventional method can be used herein, it is also possible to use the method to be described later.

A total demand curve producing unit 101A produces a total demand curve based on the demand data 100B (Step S101A).

A portfolio producing unit 102 firstly produces an electricity portfolio as a starting point (Step S102). For this portfolio, it is possible to assume that one or plural generators owned by a power company are employed at a given proportion in order to supply electricity for the whole demand, or it is also possible to assume that electricity to be generated by the owned generators and electricity to be procured from the market at a proportion 2:1.

A power generation planning unit 103 produces the electricity procurement plan while comparing the obtained power generation cost with an electricity price 100C in the spot market (Step S103). The procurement plan produced in this step is quantitatively balanced with the demand. However, the risk is not necessarily optimized at this stage. Accordingly, the portfolio risk, such as the VaR, is evaluated with a profit distribution evaluation unit 105 by use of volatility, which is historical volatility, which is calculated by using amounts demanded and past data for spot market prices to be provided from a database 104 (Steps S105 and S106).

A risk tolerance judging unit 107 performs judgment of a risk tolerance by use of risk amount evaluation data (Step S107). When this value is equal to or greater than the tolerance, a portfolio reorganizing unit 108 reduces the risk by reorganizing the portfolio (Step S108). When it is not possible to reduce the portfolio risk to the tolerance or below, reduction of the supply is also considered. On the contrary, when the portfolio risk is lower than the tolerance, a profit maximization judging unit 107-1 judges whether or not the profit is maximum. In a case that the profit is not maximum, an investment in another asset having a higher risk and a higher return is also considered in the portfolio reorganization unit 108 (Step S107-1). In this way, the profit is maximized while maintaining the risk within the tolerance. Moreover, a power generation-procurement plan executing unit 109 executes the procurement of electricity based on the produced power generation-procurement plan (Step S109).

A position review unit 111 reviews portfolio risks 110A, positions 110B and current ALM data 100C everyday (Step S111) and stores the result of review in a database 112 (Step S112). An output unit outputs a risk-related index (Step S113). Furthermore, when necessary, the position review unit 111 reorganizes the portfolio through transactions with a market and the like. When appropriate, the position review unit 111 performs risk hedging of the portfolio by use of a risk hedge executing unit 114 (Step S114). The risk hedge executing unit 114 can use instruments such as options, swaps, and futures.

Next, as a third embodiment of the present invention, an electricity procurement plan producing unit 1004 of the power trading risk management system will be described with reference to FIG. 11. Here, together with the input data 110A to 110C, emission right market data 121 and weather derivative price data 122 are used in addition to the second embodiment shown in FIG. 9. Note that other functions of the third embodiment shown in FIG. 11 are similar to those in the second embodiment shown in FIG. 9.

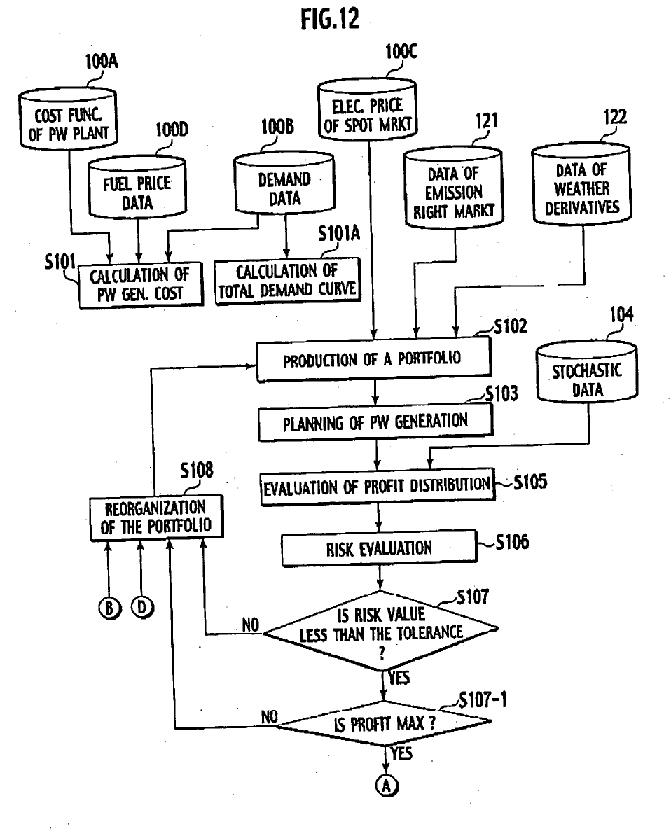

A process carried out by the electricity procurement plan producing unit 1004 is as a flowchart shown in FIG. 12 and FIG. 10B. A difference from the flowchart of the second embodiment shown in FIG. 10A and FIG. 10B is that, in this embodiment, a price of emission right of carbon dioxide 121 and a weather-related derivative 122 are to be included at the Step S102. Other steps are similar to those of the second embodiment.

By combining an emission right for carbon dioxide or the like with the existing portfolio, it is possible to maximize the profit while maintaining the risk of fluctuations of the electricity prices within the tolerance. When the electricity portfolio includes power generation facilities such as a thermal power plant designed to emit greenhouse gases, and when emission rights for the gases are being traded in a market, the profit may be further optimized by stopping the thermal power plant and selling the emission right at the same time. The emission right in this case is not only limited to carbon dioxide, but is also applicable to other gases such as SO₂ and NOₓ.

The weather derivative is normally used for hedging a weather risk. However, the demand and the price of electricity have a strong correlation with the weather. Accordingly, there is a possibility of reducing the portfolio risk by incorporating the weather derivative appropriately into the portfolio.

Upon evaluation of a future risk of the electricity price, the relation with the demand is not ignorable. The future electricity price usually has daily or weekly periodicity, and a seasonal factor on a yearly basis is also observed. Since regular fluctuations are not risk factors, such regular fluctuations need to be appropriately processed. However, regularity of the electricity price is mostly unclear and it is normally difficult to process the regularity directly. On the contrary, regularity of the electricity demand is relatively clear because the demand reflects social activities. Therefore, it is more convenient to evaluate the regularity of the price by use of the regularity of the demand and the relation between the demand and the price rather than directly processing the regularity of the electricity price. Nevertheless, the relation between the demand and the price is determined by a configuration of regional power sources, types of customers, quantity, composition, and characteristics of power systems. Accordingly, it is not possible to determine a universal relation in advance.

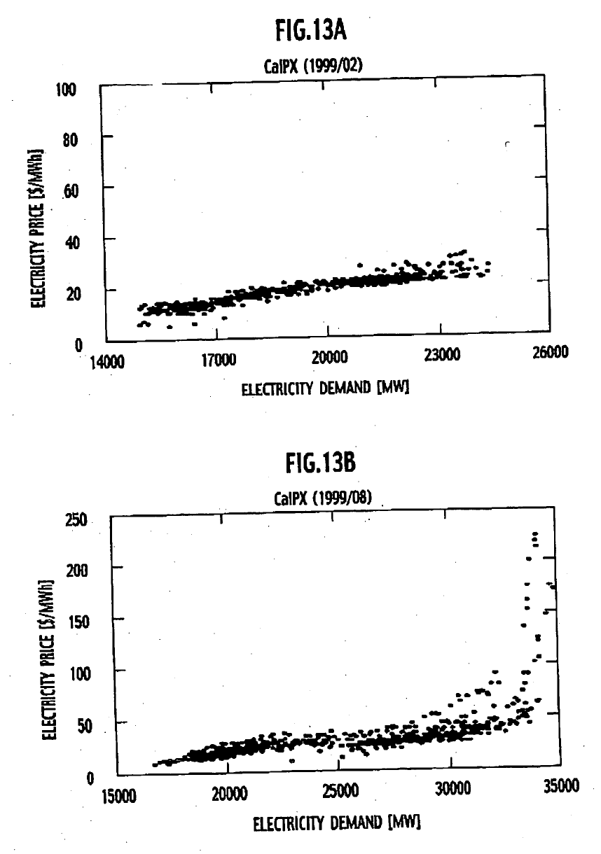

FIG. 13A and FIG. 13B show a relation between the electricity price and the demand at the CalPX. FIG. 13A represents data in February, 1999 and FIG. 13B represents data in August, 1999. As apparent from these graphs, the relation is changed depending on the season even in the same region. This is attributable to the fact that types of operating power source facilities are different depending on demand levels. Moreover, in the relation between the demand and the price, a so-called quantity of reserved power source is important.

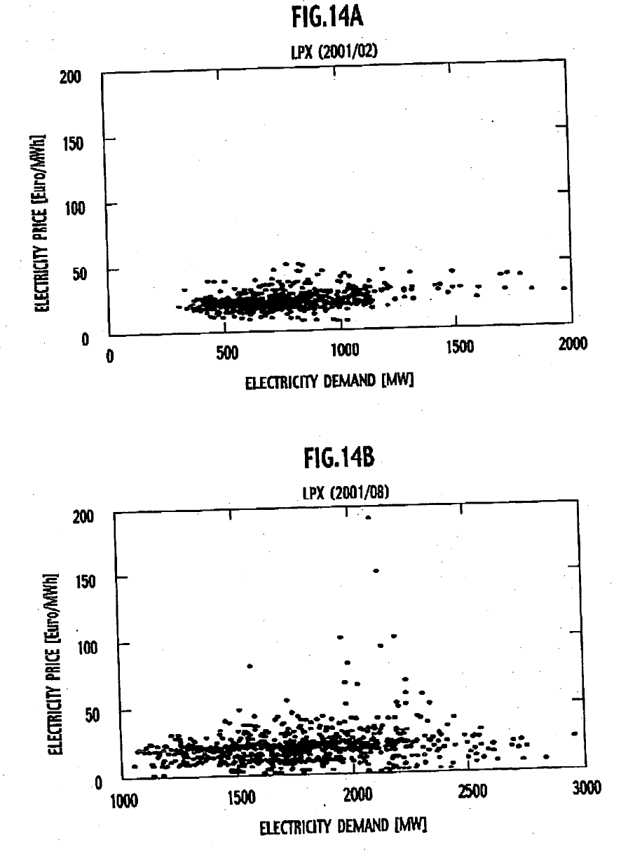

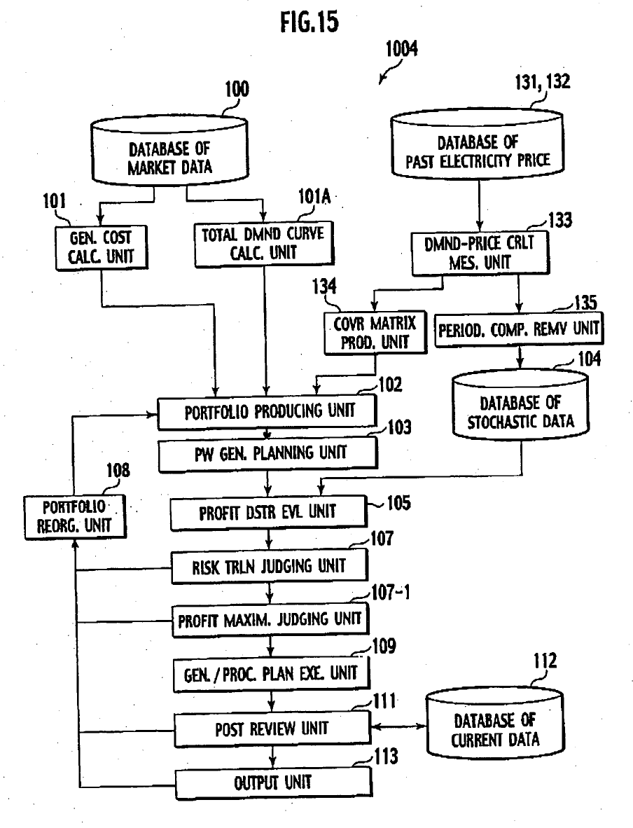

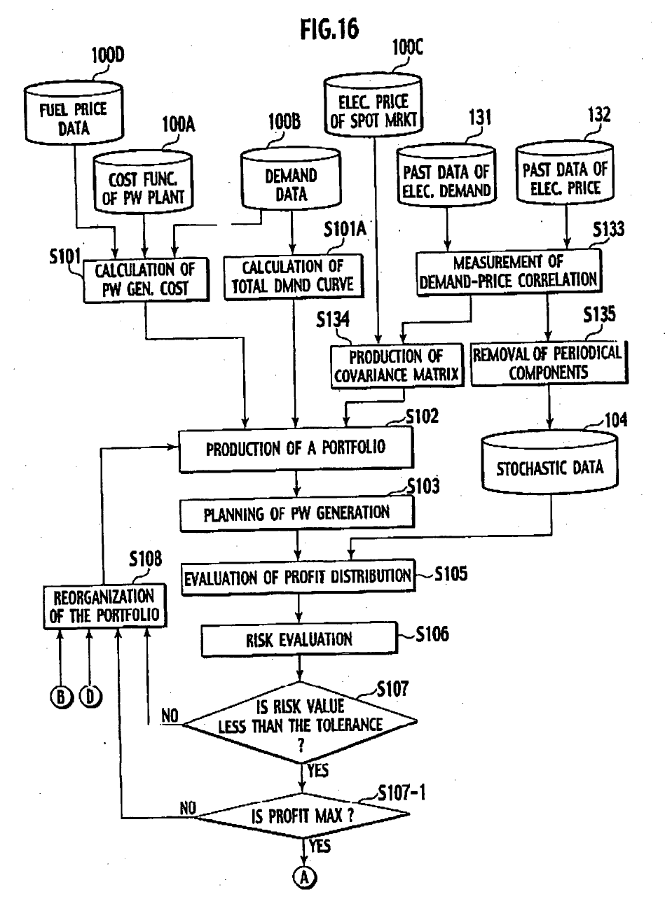

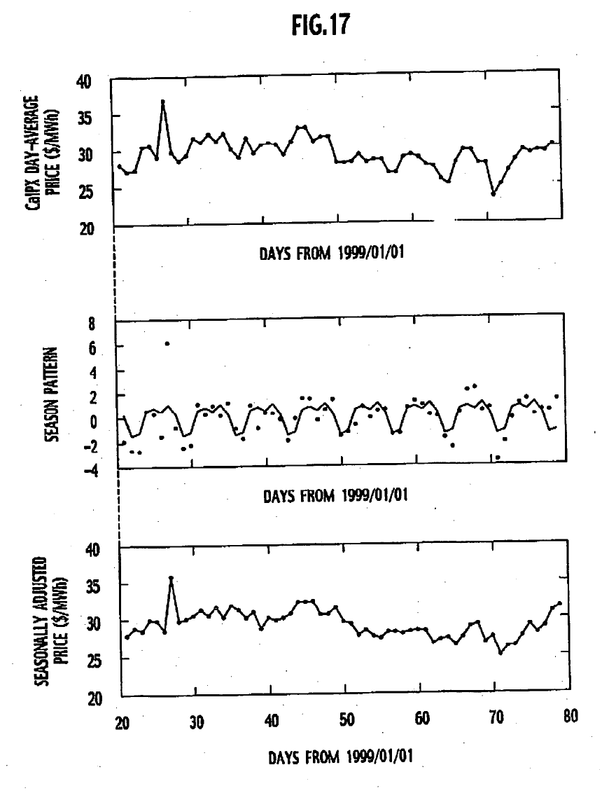

In the meantime, FIG. 14A and FIG. 14B are examples of a relation between the demand and the price at Leipzig Power Exchange. The examples apparently show larger variation as compared to the case of California Power Exchange. Such variation needs to be taken into account for the risk evaluation as an uncertainty.

As described above, the relation between the electricity demand and the electricity price, which varies depending on the country, region, and season, should be appropriately adopted for the risk evaluation.

FIG. 15 shows another functional configuration of an electricity procurement plan producing unit 1004 of a fourth embodiment of the present invention, which can be employed in the power trading system of the first embodiment. The system of this embodiment is characterized in that the portfolio is composed by use of the relation between electricity demand and the electricity price. A demand-price correlation measuring unit 133 finds a correlation equation and a correlation coefficient by means of regression analysis using past electricity demand data 131 and past electricity price data 132. The demand-price correlation measuring unit 133 outputs the correlation equation and the correlation coefficient thus obtained to a covariance matrix producing unit 134 and a periodicity component removing unit 135 (Step S133).

The covariance matrix producing unit 134 produces a covariance matrix (Step S134). Meanwhile, the periodicity component removing unit 135 removes a periodicity component of the electricity price, and then produces and evaluates statistical data 104 such as appropriate price volatility out of the price data after removal of the periodicity component therefrom (Step S135). In the meantime, correlation data between the demand and the price can be also used for composition of the electricity portfolio in a portfolio producing unit 102 (Step S102). Other functions of the system according to the third embodiment are similar to those in the second embodiment shown in FIG. 9.

The electricity price shows the daily, weekly, or yearly periodicity in accordance with changes in the demand. This periodicity is essentially different from a random change, but is a regular variation portion. For this reason, direct data processing may result in overestimation (or underestimation) of the variation portion, which is a risk. Accordingly, when evaluating the future risk by use of the past data, it is necessary to remove the periodicity component from the past data appropriately. There are various methods for removing the periodicity component. However, one typical practice is to decide coefficients (aⱼ, bⱼ) by a least-square method on the assumption of a function form as shown in the following equation (15):

$$S ( i ) = {a}_{0} + {\sum }_{j = 1}^{m} \{ {a}_{j} cos ( \frac{2 π}{L / j} i ) + {b}_{j} sin ( \frac{2 π}{L / j} i ) \} \qquad ( 15 )$$

where, i is time or days and L is a length of the period, which is equal to 24 on the daily basis and or to seven on the weekly basis. As for the value m, a value around 12 is sufficient for the daily data and a value around three is sufficient for the weekly data. FIG. 14 shows a result of removing the periodicity component out of the original data according to the above-described method.

When evaluating the portfolio risk, risk sensitivity E, which is exposure, needs to be considered. The risk sensitivity E is defined by the following equation (16):

$$E = \frac{Δ P}{Δ x} \qquad ( 16 )$$

where, Δx is a change in the market data and ΔP is a change in the portfolio value in that event. For example, if x is an interest rate, then E is the duration (of the conventional technique). If x is a stock index, then E is a so-called beta value. Moreover, if x is an underlying asset of an option and P is an option price, then E corresponds to a delta factor of the option. The E in this case is a primary differential coefficient. However, it is also possible to further consider an amount corresponding to convexity of an interest-rate risk or a gamma factor of an option by taking consideration of a second differential coefficient.

Next, as a fifth embodiment of the present invention, a risk evaluation method carried out in the power trading risk management system of the first embodiment will be described. The power trading risk management system according to the first embodiment described above is based on an assumption of using the normal distribution, which is generally used as the distribution, of the daily rates of return. However, as described above, the distribution of the daily rates of return is largely deviated from the normal distribution in the case of the electricity price. Such a fact may constitute a large risk. Accordingly, it is necessary to evaluate deviation of the distribution of the daily rates of return from the normal distribution at any time.

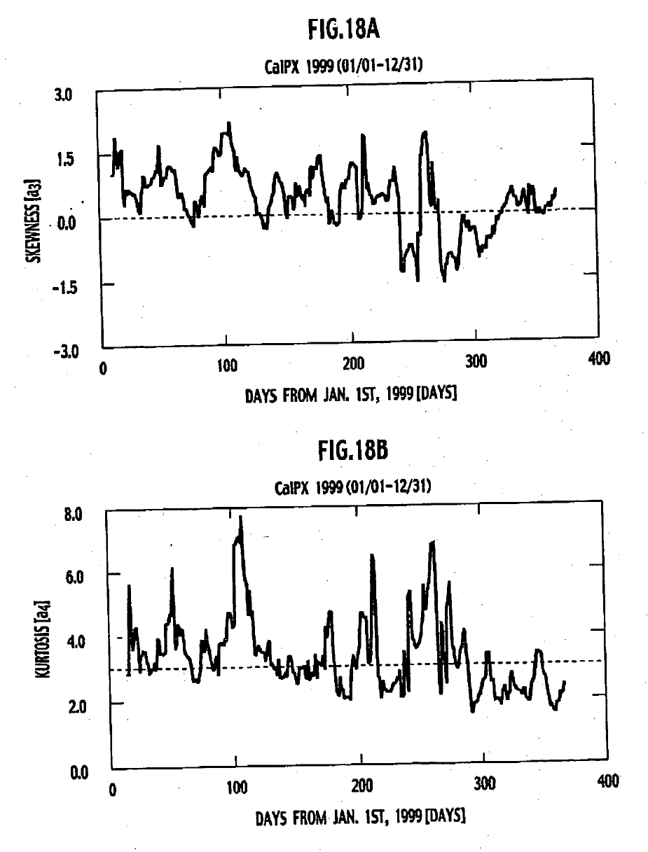

FIG. 18A and FIG. 18B are graphs plotting variations with time of skewness a₃ and kurtosis a₄ by using the data of California Power Exchange (CalPX). If the distribution of the daily rates of return is close to the normal distribution, then a₃˜0 and a₄˜3 hold true. It is possible to check the deviation from the normal distribution by checking these values. Moreover, by calculating a stochastic amount JB (Jarque-Bera) defined by the following equation (17), for example, it is possible to evaluate a degree of deviation from the normal distribution:

$$JB = \{ \frac{n}{6} {a}_{3}^{2} + \frac{n}{24} {( {a}_{4} - 3 )}^{3} \} • {X}^{2} ( 2 ) \qquad ( 17 )$$

where, n is the number of the data. According to the statistic theory, it is evident that JB accords to a χ² distribution for the degree of freedom 2. Therefore, it is apparent that the distribution of the daily rates of return cannot be used as the normal distribution at 95% confidence level when JB is equal to or greater than 5.991. The power trading risk management system of the fifth embodiment is characterized in that the risk evaluation is more strictly executed by use of the above-described values. Note that the stochastic data storage 104 stores necessary data in advance.

Next, as a sixth embodiment of the present invention, another risk evaluation method carried out in the power trading risk management system of the first embodiment will be described. In the risk evaluation to be carried out by the profit distribution evaluation unit 105, the distribution obtained from the market is often used directly. However, such an approach is not accurate in a strict sense. The distribution of the daily rates of return must be obtained based on a price volatility model without contradictions.

Accordingly, the system of this embodiment is characterized in that a financial Boltzmann model (Y. Uenohara et al., Proc. 5th JAFEE Int. Nat. Conf., pp. 18, 1999) is used as the price volatility models, that calculation is executed in accordance with the financial Boltzmann model upon evaluation of a variation component, and that to obtain a risk-neutral probability distribution, risk measurement is executed.

The financial Boltzmann model is an expansion model of a diffusion model, which can evaluate a derivative security price relevant not only to the normal distribution but also to a price distribution of a wider range. The Boltzmann model allows incorporation of a fat tail without damaging continuity. In this way, duplicatability is guaranteed and risk hedging of a derivative security is thereby facilitated. The financial Boltzmann equation is expressed as the following equation

$$\frac{\partial P ( S , t )}{\partial t} + Sr \frac{\partial P ( S , t )}{\partial S} + \int ⅆ v ⅆ μ [ Sv μ \frac{\partial p ( S , v , μ , t )}{\partial S} + {Λ}_{T} ( S , v ) p ( S , v , μ , t ) - \int ⅆ {v}^{′} ⅆ {μ}^{′} Sp ( S , v , μ , t ) {Λ}_{S} ( S , {v}^{′} , {μ}^{′} \to v , μ ) ] = δ ( S - {S}_{0} ) δ ( t ) \qquad ( 18 )$$

where, P is a risk-neutral probability measure of an underlying asset S, t is time, v is a logarithmic rate of return, μ is a direction of price change, Λ_{T} is a collision frequency, Λs is a scattering term representing a memory effect, and S₀ is S when t=0. In the meantime, P(S, t) is expressed by the following equation (19):

P(S,t)=∫dvdμp(S,V,μ;t) (19)

The scattering term As is calculated on an assumption of a function form as shown in the following formula (20) as the distribution of the logarithmic daily rates of return:

$$\frac{v}{T ( {v}^{′} )} exp [ - \frac{v}{T ( {v}^{′} )} ] \qquad ( 20 )$$

Meanwhile, T(v) is a parameter corresponding to temperature, which is expressed by the following equation (21):

T(v)=T₀(1+c₀v+g₀v²) (21)

Here, T₀, c₀, and g₀ are constants.

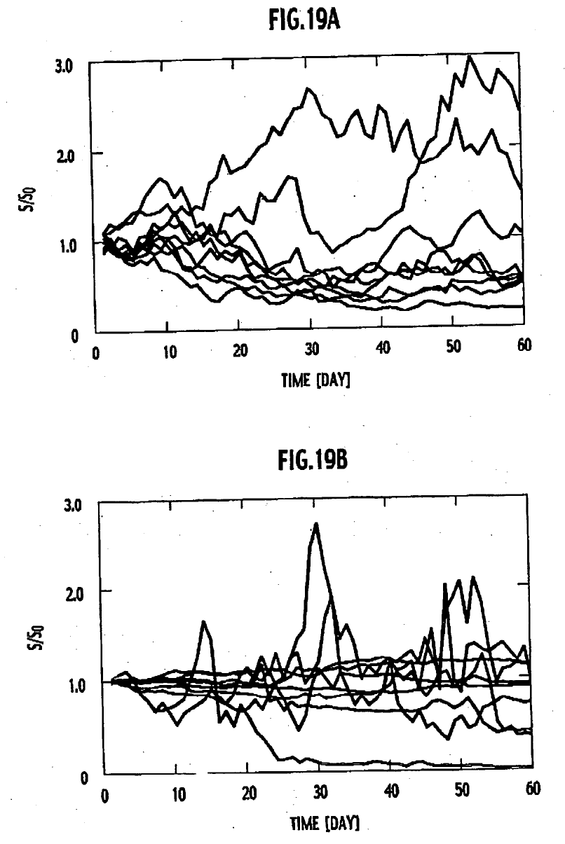

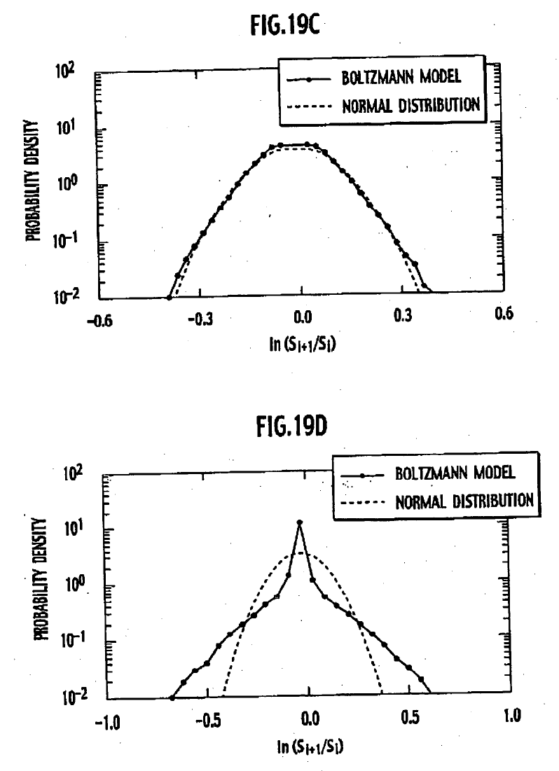

FIG. 19A to FIG. 19D are calculation examples of the fluctuations of the electricity prices by use of the financial Boltzmann model. These graphs also include the corresponding distributions of the daily rates of return. FIG. 19A is a calculation example when the distribution of the daily rates of return is close to the normal distribution. FIG. 19B is a result when the distribution of the daily rates of return is largely different from the normal distribution. In the financial Boltzmann model., it is possible to find a risk-neutral probability density of a distribution in a wide range by selecting T₀, c₀, and g₀ described above.

Since the financial Boltzmann model can treat the distribution deviated from the normal distribution as described above, it is apparent that the financial Boltzmann model approximates the actual daily rates of return more properly than the normal distribution, and is therefore suitable for describing the fluctuations of the electricity prices.

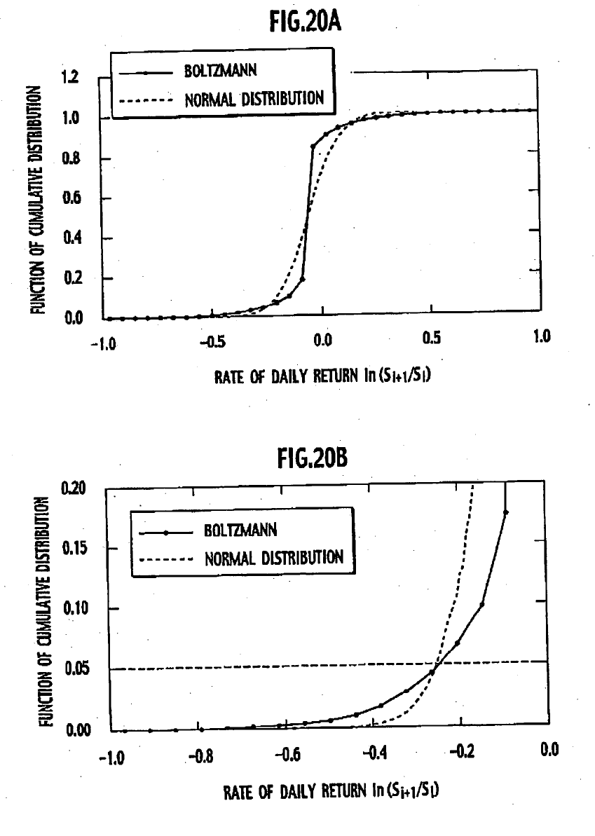

FIG. 20A and FIG. 20B are results of obtaining accumulated distribution functions regarding the distribution of the daily rates of return obtained by the financial Boltzmann model and regarding the normal distribution in the case of FIG. 19A and FIG. 19B. For example, when evaluating the value at risk at 95% confidence level, reference should be made to the daily rates of return in the drawings where the accumulated distribution is equal to 0.05. FIG. 20B is an expanded view of FIG. 20A. In terms of values of the daily rates of return corresponding to the accumulated distribution at 5%, which corresponds to the VaR, the values are not largely different between the financial Boltzmann model and the normal distribution. However, the financial Boltzmann model shows a higher probability of causing a larger loss. This aspect corresponds to the actual situation as shown in FIG. 5.

Although the above-described results correspond to the case where the VaR figures are not largely different by coincidence due to the difference in distribution, the VaR figures may be largely different when the confidence level of the VaR accounts for 99% or 90%.

In the above-described results, a method of selecting the parameters To, co, and go has not been specified in the calculation of the financial Boltzmann model. For example, a conceivable method is to select the parameters similarly to fitting to the market data.

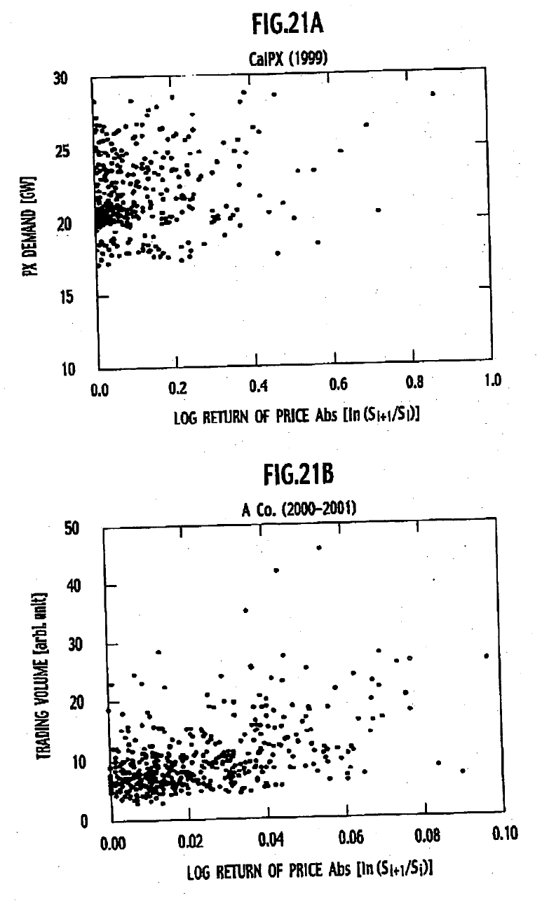

Alternatively, it is also possible to select T₀, c₀, and g₀ similarly to a method practiced in the financial and securities field. FIGS. 21A and 21B show relations between the logarithmic daily rates of return and the demand, or a traded volume, in terms of the CalPX electricity prices and the stock prices of Company A. Despite ambiguity, it is still possible to observe similar relations from these graphs such that the demand or the traded volume is increased along with an increase in the rate of return. At least, clear characteristic difference is not recognized between the electricity price and the stock price. Therefore, it is deemed possible to apply a method based on a memory effect of the daily rates of return, which is used in the financial and securities fields (Y. Uenohara et al., Proc. 5th JAFEE Int. Nat. Conf., pp. 18, 1999).

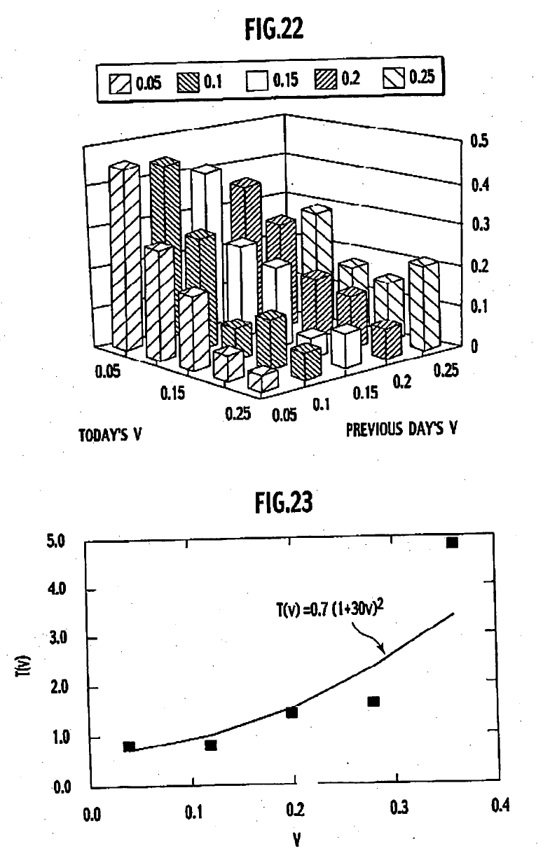

FIG. 22 and FIG. 23 show outlines of this method. FIG. 22 shows a relation between a daily rate of return on a current day and a daily rate of return on the preceding day. It is apparent from this graph that the shape of the distribution of the daily rate of return on the current day is more flattened as the daily rate of return on the preceding day is greater. The parameters T₀, c₀, and g₀ can be determined by means of fitting with equations 18 and 19. FIG. 23 shows a result of fitting. In the above-described method, the risk management with higher accuracy can be achieved by using the financial Boltzmann model for the risk evaluation of the electricity portfolio.

Next, a power trading risk management system according to a seventh embodiment of the present invention will be described. The power trading risk management system of this embodiment is characterized by its profit optimization process carried out in a portfolio producing unit 102 on producing a portfolio as shown in FIG. 9. Therefore, the functional configuration of the system of this embodiment is similar to that of the first embodiment. The portfolio producing process is also similar to that of the flowchart shown in FIG. 10A and FIG. 10B.

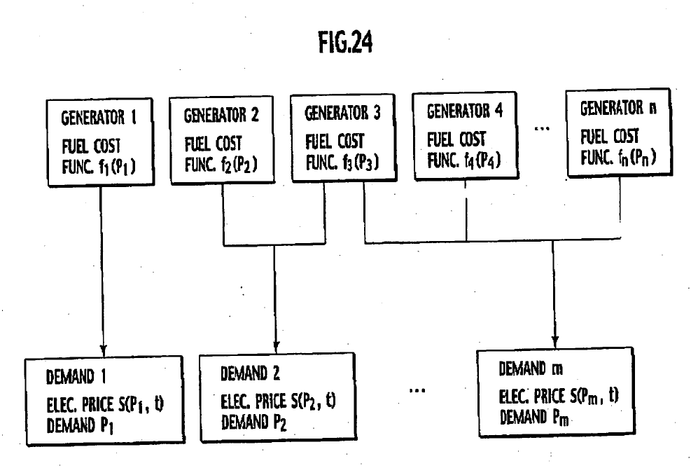

FIG. 24 shows a functional configuration of the portfolio producing unit 102 of this embodiment. Here, the electricity generated by a plurality of power plants (1) to (n) with different costs are allocated to a plurality of customers (1) to (m) with different prices and different amounts demanded.

When deciding an optimum power generator output of each power generator in response to a given electricity demand, power generation outputs have been heretofore allocated so as to equalize incremental fuel costs in accordance with the equations (9) to (13) as described above. However, when the power trading is liberalized, there is a possibility that the electricity price varies depending on the time or a counterpart. The allocation of the power generator to the demand is decided by the ALM approach and the methods of the portfolio optimization as described in the first to sixth embodiments. In this case as well, the amount of power generation with each generator needs to be determined by use of a fuel cost function. Nevertheless, whereas the generation power has been conventionally allocated so as to minimize the fuel costs, the generation power is allocated so as to maximize the profit in the present invention. Here, for the purpose of simplification, consideration will be made on the simplest case where there are two power generators and two customers, and a power generator 1 supplies the electricity to a demand 1 while a power generator 2 supplies the electricity to a demand 2. In this case, the equation 11 can be replaced by a question of deciding P₁ and P₂ for maximizing the following formula (22) under the condition of P₁+P₂=P₀:

∫₀^{T}[P₁S₁(P₁,t)+P₂S₂(P₂,t)]dt−∫₀^{T}[f₁(P₁)+f₂(P₂)]dt (22)

where, T is a term of a contract, P₁ and P₂ are amounts of electric energy of the demand 1 and the demand 2, and S₁ and S₂ are prices per unit electricity for the demand 1 and the demand 2, all of which constitute functions between amounts demanded and time that generally vary depending on customers. Meanwhile, f₁ and f₂ are power generation cost functions.

Here, for the purpose of simplification, an effect of the present invention will be indicated based on an example in which S₁ and S₂ do not rely on demand levels and are constant at any time, which means at no risk. In this case, the formula (22) is modified to the following formula (23), because the formula (22) does not rely on the time and the integrals are removable: P₁S₁+P₂S₂−[f₁(P₁)+f₂(P₂)] (23)

Accordingly, assuming that

F=P₁S₁+P₂S₂−[f₁(P₁)+f₂(P₂)]+λ(P₀−P₁−P₂) (24)

the condition for maximizing the profit is expressed by the following equations (25):

$$\begin{matrix}\frac{\partial F}{\partial {P}_{1}} = {S}_{1} - \frac{\partial {f}_{1}}{\partial {P}_{1}} - λ = 0 \\ \frac{\partial F}{\partial {P}_{2}} = {S}_{2} - \frac{\partial {f}_{2}}{\partial {P}_{2}} - λ = 0\end{matrix} ) \qquad ( 25 )$$

By resolving the equations (25) on the assumption that f₁(P₁)=a₁P₁² and f₂(P₂)=a₂P₂², the following equations (26) are obtained:

$$\begin{matrix}{P}_{1} = \frac{( {S}_{1} - {S}_{2} ) / 2 + {a}_{2} {P}_{0}}{{a}_{1} + {a}_{2}} \\ {P}_{2} = \frac{( {S}_{2} - {S}_{1} ) / 2 + {a}_{1} {P}_{0}}{{a}_{1} + {a}_{2}} \\ F = \frac{{( {S}_{1} - {S}_{2} )}^{2} / 4 + {a}_{1} {a}_{2} {P}_{0}^{2}}{{a}_{1} + {a}_{2}}\end{matrix} ) \qquad ( 26 )$$

These results are identical to the results of the above-described equations (11) to (13) when S₁=S₂. The foregoing results reflect the case where S₁ and S₂ do not depend on the time or the demand levels. However, when S₁ and S₂ depend on the time or the demand levels, it is obvious that the results of this method are different from the results of the conventional methods, and that the results of the present invention will bring a larger profit.

Description has been made above regarding the case without the risk. In reality, however, S₁ and S₂ vary with time, in other words, there is a risk. In this case as well, optimum solutions can be found by use of the formula (22). When variances (σ²) of random fluctuations between S₁ and S₂ are equal to each other, the entire risk is decided solely by P₀ and σ. Therefore, P₀ should be decided so as to set the risk, such as the VaR, within the tolerance and then P₁ and P₂ should be optimized so as to maximize the profit. When S₁ and S₂ have different risks, it is necessary to calculate risk values and profits in terms of numerous combinations of P₁ and P₂. Similarly, optimization is theoretically possible even if the number of demands is increased. However, computational complexity is drastically increased. In this case, it is possible to conduct calculation in reasonable time by use of dynamic programming method or the like. Meanwhile, f₁ and f₂ become time functions when fluctuations of fuel costs are taken into account; however, a similar method is applicable.

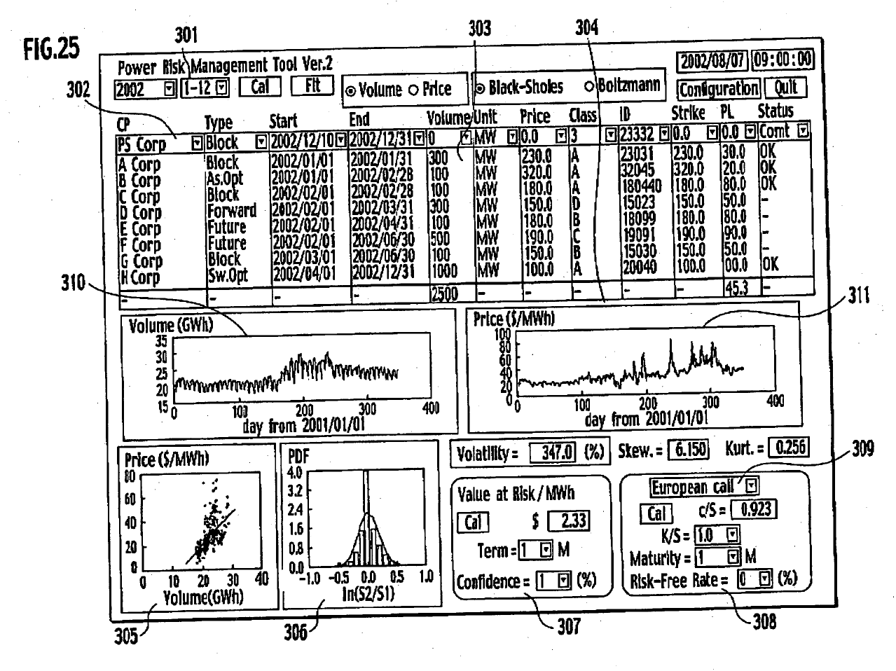

FIG. 25 shows one example of a screen layout of a risk management system for an electricity portfolio according to the present invention. Reference numeral 301 denotes targeted period, reference numeral 302 denotes new assets, reference numeral 303 denotes assets inputted in the past, reference numeral 304 denotes positions at present, reference numeral 305 denotes relations between prices and demands, reference numeral 306 denotes a distribution of a daily rates of return, reference numeral 307 denotes an evaluation portion of VaR, reference numeral 308 denotes an option period, reference numeral 309 denotes an option type, reference numeral 310 denotes fluctuations of demands in the past, and reference numeral 311 denotes fluctuations of prices in the past, respectively. This system is designed to allow a user to select either an operation using the Black-Scholes equation or an operation using a Boltzmann model.

The above-described power trading risk management system of present invention is realized by a single computer, or by a network system including, a plurality of computers connected through a network and more computers dispersed in many locations which are connected through an information network. In addition, the technical scope of the present invention also encompasses a software program which is installed in a single computer or in a computer network system for achieving the functions of the system.

What is claimed is:

1. A power trading risk management system, comprising:
an electricity procurement planning unit for producing an electricity procurement plan by combining electricity to be generated by one or plural owned power generators and electricity to be procured from a market;
a generation-procurement curve producing unit for producing a generation-procurement curve based on the electricity procurement plan;
a portfolio producing unit for producing a portfolio of electricity to be generated by owned power plants and electricity to be procured from a power trading market that is matching to the generation-procurement curve;
a risk evaluation unit for evaluating a risk of the portfolio;
a profit estimating unit for estimating a profit of electricity sale according to the portfolio;
a portfolio reorganizing unit for reorganizing the portfolio;
a best portfolio proposing unit for judging a best portfolio which can maximize the profit while maintaining the risk in the profit of electricity sale in a certain period within a tolerance among the reorganized portfolios.

2. The power trading risk management system according to claim 1, further comprising:
means for deciding a combination of power generators to be operated to maximize a profit accrued from power generation.

3. The power trading risk management system according to claim 1, further comprising:
an estimation of future electricity demand unit for estimating fluctuations of future electricity demand according to past electricity demand fluctuations; and
an estimation of electricity price fluctuation unit for estimating future electricity price fluctuations according to the past electricity demands, past price fluctuations and a relationship between electricity demand and price in a predetermined period as well as the estimated fluctuations of future electricity demand; and
the system wherein
the portfolio producing unit includes a price of an emission right for carbon dioxide in the portfolio; and
the best portfolio proposing unit judges the best portfolio which can maximize the profit while maintaining the risk in the profit of electricity sale in a certain period within the tolerance among the reorganized portfolios which are including the price of the emission right of carbon dioxide.

4. The power trading risk management system according to claim 1, further comprising:
an estimation of future electricity demand unit for estimating fluctuations of future electricity demand according to past electricity demand fluctuations; and
the system wherein
the portfolio producing unit includes a financial product related to a weather in a corresponding region in the portfolio; and
the best portfolio proposing unit judges the best portfolio which can maximize the profit while maintaining the risk in the profit of electricity sale in a certain period within the tolerance among the reorganized portfolios which are including the financial product related to the weather.

5. The power trading risk management system according to claim 1, wherein
the risk evaluating unit manages a position and calculates a risk index for the electricity portfolio by use of the relationship between demand and price which varies depending on a country, a region, and time wherein the system is operated.

6. The power trading risk management system according to claim 5, wherein
the risk evaluating unit uses at least any of volatility, risk sensitivity, skewness of a rate of return distribution, kurtosis of the rate of return distribution, a percent point of the rate of return distribution, a percent point of a price distribution, a value at risk and an earning at risk for managing the position and calculating the risk index for the electricity portfolio.

7. The power trading risk management system according to any one of claims 1 to 6 wherein
the risk evaluating unit uses a probability distribution different from a normal distribution as a distribution of the rate of return attributable to a power trading upon risk evaluation of the portfolio.

8. The power trading risk management system according to any one of claims 1 to 6, wherein
the risk evaluating unit uses a probability distribution different from a normal distribution that is calculated from a financial Boltzmann model as a distribution of the rate of return attributable to a power trading upon risk evaluation of the portfolio.

9. A power trading risk management system, comprising:
a power generation risk parameter evaluating unit for simulating a fluctuation of a profit of each power plant and evaluating a risk parameter of power generation by use of a fluctuation of a fuel price;
an electricity procurement risk parameter evaluating unit for evaluating a risk parameter of electricity to be procured from a power trading market;
an electricity demand risk parameter evaluating unit for evaluating a risk parameter of an electricity contract with each customer;
a portfolio producing unit for producing a portfolio according to a proportion of electricity to be generated by owned power plants and electricity to be procured from a power trading market, the risk parameter of power generation, the risk parameter of electricity procurement and the risk parameter of electricity contract;
a risk value evaluating unit for evaluating a risk of the portfolio;
a portfolio reorganizing unit for reorganizing the portfolio by adjusting the proportion of the electricity to be generated by owned power plants and electricity to be procured from the market to maximize a profit while maintaining the risk amount within a tolerance; and
an outputting means for deciding the proportion of the electricity to be procured from the market which can maximize the profit while maintaining the risk amount within the tolerance as an optimum combination and outputting the optimum combination as a power generation plan.

10. The power trading risk management system according to claim 9, further comprising:
means for deciding a combination of power generators to be operated to maximize a profit accrued from power generation.

11. The power trading risk management system according to claim 9, wherein
the risk value evaluating unit uses an asset and liability management method of any of maturity ladder analysis, term gap analysis, and duration gap analysis for management of the portfolio.

12. A power trading risk managing method, comprising the steps of:
producing an electricity procurement plan by combining electricity to be generated by one or plural owned power generators and electricity to be procured from a market;
producing a generation-procurement curve based on the electricity procurement plan;
producing a portfolio of electricity to be generated by owned power plants and electricity to be procured from a power trading market that is matching to the generation-procurement curve;
evaluating a risk of the portfolio;
estimating a profit of electricity sale according to the portfolio;
reorganizing the portfolio; and
judging a best portfolio which can maximize the profit while maintaining the risk in the profit of electricity sale in a certain period within a tolerance among the reorganized portfolios.

13. A power trading risk managing method, comprising the steps of:
simulating a fluctuation of a profit of each power plant;
evaluating a risk parameter of power generation by use of a fluctuation of a fuel price;
evaluating a risk parameter of electricity to be procured from a power trading market;
evaluating a risk parameter of an electricity contract with each customer;
producing a portfolio according to a proportion of electricity to be generated by owned power plants and electricity to be procured from a power trading market, the risk parameter of power generation, the risk parameter of electricity procurement and the risk parameter of electricity contract;
evaluating a risk of the portfolio;
reorganizing the portfolio by adjusting the proportion of the electricity to be generated by owned power plants and electricity to be procured from the market to maximize a profit while maintaining the risk amount within a tolerance;
deciding the proportion of the electricity to be procured from the market which can maximize the profit while maintaining the risk amount within the tolerance as an optimum combination; and
outputting the optimum combination as a power generation plan.
